(19) United States
(12) Patent Application Publication
(10) Pub. No.: US 2002/0065907 A1
(43) Pub. Date: May 30, 2002

(54) Method and apparatus for dynamically modifying service level agreements in cable modem termination system equipment

(76) Inventors: Thomas J. Cloonan, Lisle, IL (US); Daniel W. Hickey, Oswego, IL (US); Todd D. Kessler, Naperville, IL (US); William P. Ward, Oak Lawn, IL (US); Steven J. Krapp, Arlington Heights, IL (US); Jeffrey R. Shroda, Bolingbrook, IL (US); Brian J. Barker, Naperville, IL (US); Erich C. Arnold, Naperville, IL (US)

Correspondence Address: VEDDER PRICE KAUFMAN & KAMMHOLZ, 222 N LASALLE STREET, CHICAGO, IL, 60601, US

(21) Appl. No.: 09/727,394

(22) Filed: Nov. 29, 2000

(51) Int. Cl. G06F 15/173

(52) U.S. Cl. 709/223; 709/228

(57) ABSTRACT

A method and system that allow subscribers to a cable Internet data service to use a Web browser and access to the Internet via their cable Internet data service to dynamically change their service level by communicating with the cable modem manager that manages their cable modem. An alternate method and system allow a content provider that has been contacted by a subscriber to dynamically implement new “on-demand” services flows for the subscriber. With both arrangements, the subscriber can begin employing the new service flows without reinitializing their cable modem or otherwise having their data service disrupted.

### BACKGROUND OF THE INVENTION

1. Field of the Invention

The present invention relates to methods and systems for dynamically modifying service flows employed by cable modem termination system equipment and their associated cable modems.

2. Discussion of the Background Art

The term Quality of Service or “QoS” in a data network generically refers to a data network service provider's ability to guarantee to subscribers certain data rates according to various factors, such as the price of fee that a subscriber pays for certain data rates. Most computer networking products (e.g., switches and routers) have already added some type of QoS functionality to their feature sets. Currently, there are many different types of QoS standards from which to choose, and they are not all compatible with one another. Different standards committees (e.g., DiffServ, RSVP, MPLS, etc.) are still deciding which of many different QoS proposals may actually be used in the Internet, and hybrid solutions are likely to be developed in the very near future.

QoS functionality will likely eliminate the current Internet routing model that provides the same “best effort” service to all users, all packets, and all traffic flows. When QoS functions are fully enabled in a ubiquitous, end-to-end fashion across the Internet, as well as other data networks, different service levels will be permitted wherein data packets of certain data streams will be differentiated and treated differently according to different “service flows.” Specifically, high-priority packets will be routed with a lower latency and perhaps lower jitter, while low-priority packets may experience more delay and jitter. The throughput needs of each software application using a data network will determine the priority to be associated with its corresponding traffic flows through that network, and advanced software application programs may dynamically change the priority of traffic flows to match the varying needs of the user throughout the entire duration of the use of the application.

Multiple system operators or “MSOs” are companies that operate more than one information system across a communications network (i.e., a company the provides both cable TV service and Internet service). These multiple system operators and the Internet service providers that work with them are positioned to act as the QoS gatekeeper into the Internet of the future, and they will be able to capitalize on the resulting changes. This is because a multiple system operator providing Internet service can access each of its Internet service subscriber's service level contracts and can appropriately mark the priority of all packets that are injected into or returned from the Internet by its subscribers. In fact, for a multiple system operator that includes a cable data system, the headend equipment, typically referred to as the cable modem termination system or “CMTS,” is actually the first piece of trusted equipment (i.e., equipment not owned by the subscriber) through which a subscriber's data packets must pass on their way to the Internet. As is known in the art, the cable modem termination system is positioned at, or near, the headend office, and provides basic connectivity between a cable plant and the Internet.

A multiple system operator also provides customer subscription packages, and thus is able to offer (and bill for) many different subscriber service levels for its Internet service. In addition, if the cable modem termination system equipment permits, the multiple system operator will also be able to offer dynamic service level upgrades to its subscribers. This may yield even greater increases in revenues for the multiple system operator if it can maintain adequate counts on the usage of the different service levels consumed by its subscribers.

To develop this opportunity for multiple system operators, Cable Television Laboratories, Inc. (CableLabs) has driven the development of the Data Over Cable Service Interface Specifications (DOCSIS), otherwise known as the CableLabs® Certified™ Cable Modem project, of which all current and past versions are incorporated entirely herein by reference. As is well known in the art, the current version of DOCSIS, DOCSIS 1.1, defines a minimal set of QoS features for all compliant cable modem termination system products. DOCSIS 1.1 does not yet specify a standard technique, however, for allowing subscribers (or their application programs) to initiate dynamic service level changes. Accordingly, current cable Internet service subscribers are precluded from making dynamic service level changes. There is therefore a need for a mechanism to allow a cable Internet service subscriber to dynamically change the service flows of his or her Internet service.

### SUMMARY OF THE INVENTION

Advantageously, various embodiments of the invention allow subscribers to use a Web browser and access to the Internet via the cable Internet data service to dynamically change their service level by communicating with the cable modem manager that manages their cable modem. Other embodiments of the invention allow a content provider that has been contacted by the subscriber to dynamically implement new “on-demand” services flows for the subscriber. In all of these embodiments, the multiple system operator can begin providing the new service flows without reinitializing the cable modem or otherwise disrupting data service to the subscriber.

### BRIEF DESCRIPTION OF THE DRAWINGS

FIG. 1 illustrates a cable data computer network according to one embodiment of the invention.

FIGS. 2A-2C illustrate Web pages showing different service level agreement information according to one embodiment of the invention.

FIG. 3 illustrates the service level package definition flow according to one embodiment of the invention.

FIGS. 4 and 5 show the cable data service subscription and cable modem registration processes according to one embodiment of the invention.

FIGS. 6A and 6B illustrate a method for dynamically changing a subscriber's current service level package according to one embodiment of the invention, while

FIGS. 6C and 6D illustrate a method for dynamically changing a subscriber's current service level package according to another embodiment of the invention.

FIG. 7 shows a request service level agreement change page according to one embodiment of the invention.

FIG. 8 depicts a confirm service level agreement change page according to one embodiment of the invention.

FIG. 9 illustrates a service level agreement change confirmation page according to one embodiment of the invention.

FIGS. 10A-10B show a method for dynamically creating a new service flow on demand according to one embodiment of the invention.

FIG. 11 shows the relationship between a SNMP agent, a management information base, and a DSx manager according to one embodiment of the invention.

FIG. 12 illustrates the components of a management information base according to one embodiment of the invention.

FIG. 13 shows a method for generating a DSA request according to one embodiment of the invention.

FIG. 14 shows a method for generating a DSD request according to one embodiment of the invention.

FIG. 15 shows a method for generating a DSC request according to one embodiment of the invention.

### DETAILED DESCRIPTION OF PREFERRED EMBODIMENTS

### I. Overview

In a data network that is cable of providing different service levels to different service subscribers, various embodiments of the invention conveniently allow cable service subscriber to change the quality of his or her Internet service (i.e., service level) through a Web site computer or other Internet-accessible or other data-network accessible computer, all of which are referred to hereafter as a “Web site controller,” provided by, or for the benefit of, the subscriber's multiple service operator or other Internet service level gatekeeper or controller, all of which for convenience are collectively referred to hereafter as “multiple service operators.” When a subscriber chooses to change his or her service, the subscriber preferably accesses the multiple service operator's Web site and submits a request for the change in service. In response, the Web site determines the new service level (or service flow) to be used by the subscriber, either from the subscriber or from another source, as will be explained in detail below. The Web site then forwards the new service level to be provided to the subscriber, onto the cable modem termination system associated with the subscriber, which in turn changes the service level parameters employed by the subscriber's cable modem.

Before the Web site controller can forward the new service level parameters to the cable modem termination system, however, the multiple service operator's Web site controller must first determine the IP address at which the cable modem termination system for the subscriber requesting a service level change can be contacted. It must also determine the particular IP address for the cable modem that should receive the new service level parameters. The multiple service operators Web site controller accomplishes this by a data transfer to a cable modem manager that is maintained by the multiple system operator.

More particularly, when a subscriber contacts the multiple service operator's Web site controller to request a service level change, the multiple service operator's Web site controller (which might be a personal computer or a network of computers that provide the Web site functionality, which is well known to those skilled in the art) obtains the Internet Protocol (IP) address for the subscriber's computer. The multiple service operator's Web site controller then provides this address to the multiple service operator's cable modem manager. Based upon the subscriber's IP address, the cable modem manager retrieves from its database the current IP address for the multiple service operator's cable modem termination system and the permanent Media Access Control (MAC) address for the subscriber's cable modem, and passes these addresses back to the multiple service operator's Web site controller. With these addresses, the Web site controller can forward the new service level designations to the multiple service operator's cable modem termination system, so that the appropriate service level parameters are passed on to the subscriber's cable modem.

With alternate embodiments of the invention, the cable modem manager delivers the new service level designations directly to the cable modem termination system servicing the subscriber. According to still other embodiments of the invention, a content provider is allowed to create an “on-demand” service level for the subscriber when the subscriber seeks to obtain content from the content provider. With these embodiments, the content provider obtains the IP addresses for the subscriber's cable modem and its associated cable modem termination system from the cable modem manager. The content provider then delivers the new service level designations to the cable modem termination system based upon the content that the subscriber is obtaining from the content provider.

Once the cable modem termination system has received the new service level designations from the Web site controller, the cable modem manager or a content provider, the cable modem termination system generates requests to the cable modem to change the service flow between the cable modem and the cable modem termination system. A management information base according to the invention conveniently allows the cable modem termination system to dynamically form these requests with a variety of characteristics. More specifically, the management information base employ tables that may be linked together to define the characteristics of a request to the cable modem to change the service flow between the cable modem and the cable modem termination system.

### II. Description of a Cable Data Computer Network According to Various Embodiments of the Invention

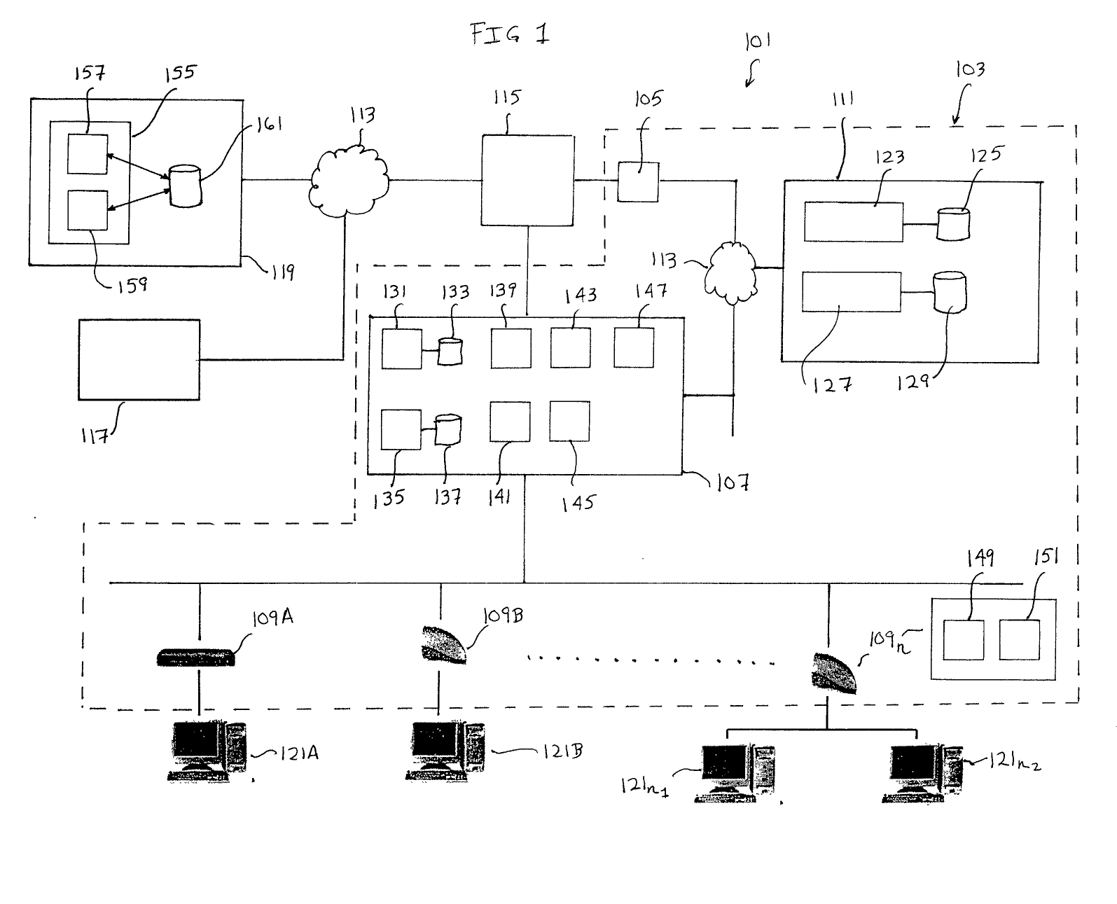

A cable data computer network 101 according to various embodiments of the invention is shown in FIG. 1. As seen in this figure, the network 101 includes an operations network 103 formed of interconnected computers or microprocessors that is maintained by a multiple service operator. The operations network 103 includes a firewall computer/processor 105, for protecting the network 103 from unwanted communications, and a cable modem termination system or “CMTS” 107, which is connected to a number of cable modems 109A, 109B, . . . 109η. The operations network 103 also includes a cable modem manager 111, connected to the firewall 105 and the cable modem termination system 107 via the Internet 113.

As conventionally known, the firewall 105 and the cable modem termination system 107 are connected to the Internet 113 through a gateway router 115. Through this connection, the operations network 103 can communicate with a service level agreement manager server 117, which will also be discussed in detail below. The operations network 103 can also use this connection to communicate with third-party content servers associated with the multiple service operator, such as the content server 119 shown in FIG. 1. As will be understood by those of ordinary skill in the art, the content server 119 may be operated by a third-party, other than the subscriber and the multiple service operator, to provide particular content, such as movies, recorded music, or software application interfaces, to a subscriber. Also, the content server 119 may be embodied by an individual computer or a combination of networked computers operating together.

The operations network 103 is also connected through the cable modems 109A, 109B, . . . 109η to one or more pieces of customer premises equipment (CPE) 121A, 121B, . . . 121η₁ and 121η₂. The customer premises equipment 121 may comprise, for example, personal computers, Internet capable televisions, wireless interfaces for wireless devices, etc. It should be noted that, while the customer premises equipment 121 are connected to the operations network 103, they do not have access to any of the components of the operations network 103. Instead, as will be appreciated by those of ordinary skill in the art, the connection to the operations network 103 is only to provide the customer premises equipment 121 with access to the Internet 113. As is also known in the art, each cable modem 109 may be connected to one or more pieces of customer premises equipment 121 using a Cable Modem Customer Interface or “CMCI,” or any other suitable type of interface. The interface may be established using, e.g., a 10BT or USB Ethernet connection.

Turning back now to the cable modem manager 111, it includes a Trivial File Transfer Protocol or “TFTP” server 123 having a cable modem configuration file storage 125. The cable modem configuration file storage 125 stores the configuration files each cable modem requires to properly initialize and begin operating. As will be discussed in detail below, the TFTP server 123 retrieves the cable modem configuration files from the cable modem configuration file storage 125, and transmits them to the cable modems 109 upon their initialization.

The cable modem manager 111 also includes a Dynamic Host Configuration Protocol or “DHCP” server 127 with a DHCP map storage 129. As known in the art, the DHCP server 127 dynamically assigns Internet protocol (or “IP”) addresses to the cable modems 109. The DHCP server 127 also stores the identity of the TFTP server 123 and the TFTP file on the TFTP server 123 that contains the cable modem's default cable modem configuration. More particularly, the DHCP server 127 stores the relationship between the IP address it has assigned to a cable modem 109, and the TFTP server 123 and the TFTP file name containing the configuration file for that cable modem 109 on the DHCP map storage 129.

Further, the cable modem manager 111 may also include a Time Of Day or “TOD” server (not shown) for acquiring the network time, a Domain Name System (DNS) server (not shown) for answering domain name system queries, and, optionally, a Lightweight Directory Access Protocol (LDAP) server (not shown) for extracting information from a hierarchical directory such as a X.500 directory.

Also, if the operations network 103 uses more than one cable modem termination system 107, the cable modem manager 111 will include a cable modem termination system database that associates each cable modem 109 in the operation network 103 to its cable modem termination system 107. For example, the cable modem termination system database may correlate the MAC address for each cable modem with the IP or MAC address for its associated cable modem termination system 107. Some or all of the servers that make up the cable modem manager 111 can be implemented on a single computer, or on a network of computers operating together.

Referring now to the cable modem termination system 107, it includes a service level agreement (or “SLA”) agent 131 and a service level agreement definitions storage 133. As will be explained in detail below, a service level agreement defines the QoS parameters for a subscriber's Internet service. The service level agreement definitions storage 133 stores the service level agreements that are used by the cable modem termination system 107, and the service level agreement agent 131 manages the entry and retrieval of service level agreement definitions into and from the service level agreement definitions storage 133.

The cable modem termination system 107 also includes a subscriber data record (or “SDR”) manager 135 and a subscriber data record storage 137. The subscriber data record storage 137 stores information regarding each subscriber, such as the MAC address of a cable modem 109 associated with the subscriber. The subscriber data record manager 135 then manages the entry and retrieval of subscriber data into and from the subscriber data record storage 137.

The cable modem termination system 107 also incorporates a DHCP relay agent 139 and a cable modem registration application 141. As will be explained below, the DHCP relay agent 139 relays a DHCP request for an IP address from the cable modem 109 to the DHCP server 127, while the cable modem registration application 141 registers the MAC address and the DOCSIS QoS parameters for a cable modem 109 associated with the cable modem termination system 107 during the registration process for the cable modem 109.

Further, the cable modem termination system 107 has a dynamic service manager or “DSx” manager 143, a Simple Network Management Protocol or “SNMP” agent 145, and a DSx management information base, or “MIB” 147. The SNMP agent receives request messages to create, modify or delete service flows, and stores DSx request characteristics provided by those messages in tables of the management information base 147. Thus, the SNMP agent 145 and the management information base 147 cooperate to allow an outside software application to precisely define the characteristics of a DSx request. When a new service flow is to be implemented, the DSx manager 143 compiles these characteristics from the management information base 147 into DSx requests to the cable modems 109.

As will be appreciated by those of ordinary skill in the art, each of the service level agreement agent 131, the subscriber data record manager 135, the DHCP relay agent 139, the cable modem registration application 141 and the DSx manager 143 may be implemented as one or more processors (e.g., microprocessors or microcontrollers) with associated software, but each could also be embodied as a field programmable gate array application specific integrated circuit or sequential logic devices the cable modem. Also, the service level agreement definitions storage, the subscriber data records storage, and the management information base 147 may be a data structure conventionally implemented on a microelectronic memory medium.

The termination system 107 may be connected to the cable modem manager 111 through an operations support system interface that supports communications using, for example, SNMP and IPDR. The cable modem termination system 107 may then be connected to the gateway router 115 using a network side interface. This connection may be made via, for example, a 10/100BT or a Gigabit Ethernet connection. This network side interface carries the traffic from the customer premises equipment 121 to the Internet 113. Further, the cable modem termination system 107 may be connected to the cable modems 109 using a radio frequency interface (RFI). This interface may support a variety of communication protocols, including both SNMP and the DSx protocol.

Referring now to the cable modems 109, each cable modem 109 includes an IP initialization application 149, a cable modem configuration application 151, and a cable modem registration application 153. The IP initialization application 149 initiates a request for an IP address during the initialization procedure for the cable modem 109, while the cable modem configuration application 151 requests the cable modem configuration file from TFTP server 123. The cable modem registration application 153 then registers the cable modem 109 with its cable modem termination system 107. Each of the IP initialization application 149, the cable modem configuration application 151, and the cable modem registration application 153 may be implemented as one or more processors (e.g., microprocessors or microcontrollers) with associated software, but both could also be embodied as a field programmable gate array application specific integrated circuit or sequential logic devices.

Turning now to the service level agreement manager server 117, this server 117 may be a server device embodied on a single computer, or it may be alternately embodied on a number of different computers operating together. The service level agreement manager server 117 hosts a service level agreement manager Web site 155, which may be accessible to both subscribers and multiple service operators via the Internet 113.

Through this Web site 155, a multiple service operator can invoke a service level agreement manager application 157. The service level agreement manager application 157 allows the multiple system operator to create and modify service level package “SLP” definitions that implement the service level agreements and associated service flows the multiple system operator wishes to provide to its subscribers. The service level agreement manager application 157 may be a common gateway interface (CGI) application or, alternately, a servlet (i.e., a small Java program that runs on the service level agreement manager server 117).

On the other hand, a subscriber can invoke a subscriber service level agreement change application 159 through the Web site 155. The subscriber can then use this application 159 to dynamically change his or her Internet service quality. The subscriber service level agreement change application 159 may also be a common gateway interface (or “CGI”) application or, alternately, a servlet. Additionally, the service level agreement manager server 117 may include a service level agreement definitions storage 161 for storing service level agreement definitions.

### III. Providing for Service Flows Under DOCSIS 1.1

As discussed above, the invention allows a subscriber to autonomously change quality of service parameters, or service flows, of the Internet service provided by the multiple service operator. Accordingly, to facilitate an understanding of the invention, the provisioning of different service flows under DOCSIS that may be used by the cable modem termination system 107 and the cable modems 109 will now be discussed.

A service flow or “SF” is considered herein to be a unidirectional sequence of data packets from a particular source to a particular destination that are recognized by a cable modem 109 and its associated cable modem termination system 107, and which are then forwarded from the source to the destination using a Quality of Service (QoS) treatment specific to that service flow. The packet sequence belonging to the service flow is recognized using a set of packet classifiers that match selected IP and/or MAC header fields in the data packets. In addition to a particular QoS treatment afforded the selected packet, a service flow may also optionally give packets with a specific packet classifier a payload header suppression or “PHS” treatment as well.

DOCSIS 1.1 defines many advanced QoS features for providing one or more service flows in a communications network that are recommended (but are not required) for cable modem termination system products. In general, a feature-rich, QoS-enabled cable modem termination system provides for all of the following functions: packet classification, packet prioritization, per-flow policing, congestion control and flow control, fine-grained queuing, scheduling, and per-flow traffic shaping.

Packet classification is essentially an advanced pattern-matching function that uniquely maps each arriving data packet into a particular service flow according to a packet service level classifier (typically referred to as a packet classifier). Packet prioritization assigns a unique priority to each packet based on at least the service flow, each packet's priority being identified during classification. Per-flow policing is the continuous monitoring of the real-time bandwidth being used by each subscriber's service flow. Congestion control and flow control uses the results of policing to determine when congestion or flow control techniques such as Weighted Random Early Discard (WRED) should be employed to drop a user's packet. In some cable modem termination system implementations, this feature is provided with per-flow resolution (where the WRED technique is applied according to a data packet's particular service flow.

Fine-grained queuing allows each packet to be separated into a different queue according to its assigned priority level. Once separated, a scheduling algorithm can determine which packets should be transmitted based on the current traffic loads and the indicated priorities. Lastly, per-flow traffic shaping adjusts the jitter on packets to recreate a smooth, nearly constant-bit-rate packet stream for real-time service flows such as Voice over IP (VOIP) or streaming video.

Payload header suppression is a packet forwarding convention between the cable modem 109 and the cable modem termination system 107. It permits a range of static MAC and IP header fields to be replaced by the sender with a one byte PHS Index or “PHSI” that is later used to reconstruct the actual header by the receiver. Variable header field values that are be passed in addition to the PHSI are merged back into the static header fields during the packet header reconstruction at the receiving end. A packet classifier may be associated with zero or one PHS rules. Thus, when a packet header matches a classifier, it not only selects the associated service flow but also the associated PHS rule, if any. This causes the packet header to be reduced to the PHSI byte plus the variable header field values.

All of the data packets associated with a single service flow must have some common characteristic, such as a common pattern in their headers. Further, in addition to having a common header pattern, packets within a particular service flow also share a common set of service level parameters (such as minimum throughput, maximum throughput, fabric priority, etc.). These common service level parameters may be defined by the subscriber's service level agreement (SLA) with the multiple service operator for a particular service flow.

A service flow may internally be identified by the cable modem termination system 107 with a 32-bit service flow ID, or “SFID,” assigned by the cable modem termination system 107 when the service flow is defined. Additionally, an upstream service flow is associated with a 14-bit service ID, or “SID,” that is passed with each packet in the upstream radio frequency interface to identify that service flow to the cable modem termination system 107. The cable modem termination system 107 then relates the service ID to the service flow ID internally for further QoS and PHS treatment.

The QoS parameters that made up a service flow may also be identified by a service class name, or “SCN.” The service class name provides a convenient handle to the characteristics of the service provided by the service flow for external systems, such as billing and customer service systems. It provides a means to pre-configure a set of QoS parameters into a template that may contain all or a sub-set of default QoS parameters in the cable modem termination system 107. This type of template can then be invoked as a macro expansion of its corresponding set of QoS parameters during the creation of one or more service flows, either during registration of the cable modem 109 or by at a later time by a specific request.

The header classification patterns and their associated sets of service level parameters for a service flow are usually assigned to a subscriber during his or her service subscription, and defined in the subscriber's service level agreement with the multiple service operator. Those subscribed service level settings then must be downloaded to the subscriber's cable modem 109 and to the cable modem termination system 107 every time that the subscriber's cable modem 109 initializes. In particular, a cable modem 109 obtains an initial set of pre-configured service flows for its default settings during a registration with the cable modem termination system 107.

At the present time DOCSIS 1.1 defines only a sub-set of the protocols that are needed if subscribers are to be allowed to dynamically alter their service level agreement. This sub-set allows the cable modem termination system 107 to communicate with the cable modem 109 (or the cable modem 109 to communicate with the cable modem termination system 107) to share information about changes to the existing service level agreement settings.

This information exchange protocol for dynamic service modifications defined in DOCSIS is referred to as the DSx protocol. By convention, the letter x is generic variable that can be replaced by A for Addition, D for Deletion, or C for Change. This protocol defines requests (i.e., DSx requests) to the cable modem that create, modify or delete a service flow provided for by the cable modem. This protocol also defines responses (i.e., DSx responses) returned by the cable modem in response to DSx requests, which contain information regarding the implementation of the service flows designated in the DSx requests (i.e., confirmation of implementation, errors occurring during implementation, etc.) DOCSIS 1.1 does not yet define, however, a standard technique by which subscribers can communicate their desire for a service level change to either the cable modem 109 or the cable modem termination system 107 in order to actually initiate the exchange of DSx requests and DSx responses.

DOCSIS 1.1 service flows can exist in one of three states once they are defined: the provisional state, the admitted state, and the active state. A provisioned service flow is one that is defined between the cable modem 109 and the cable modem termination system 107, but no resources have been allocated to it. An admitted service flow is one that is going to become active in the near future (because of some external signaling negotiation that is in progress). The admitted state allows the resources for the service flow to be allocated in advance of the need, subject to a time-out value. An active service flow is one that is actually forwarding packet traffic through the cable modem 109 and the cable modem termination system 107. Data can only be transmitted on service flows that have been placed in the active service flow state.

A service flow can be created in any of these three states during the cable modem 109 registration process by the cable modem configuration file. A service flow can only be created in the active or admitted state by a DSA request, however, while any service flow can be changed to the active or admitted state via a DSC Request.

Each state of a service flow is actually associated with a set of QoS parameters that both determines the resources allocated to the service flow in that state and identifies the state that the service flow is in at the moment. Thus, a service flow may have simultaneously one, two, or three sets of QoS parameters associated with it, even though the service flow can only be in one state at a time (i.e., the most active state).

A service flow is in the provisioned state if it has only a provisioned set of QoS parameters. If a service flow has a set of QoS parameters in the provisioned state (provided only via a cable modem configuration file), this defines the maximum “envelope” for the QoS treatment from the service flow as it transitions to the admitted or active state.

A service flow is placed in the admitted state (subject to a time-out value) when it is given an admitted set of QoS parameters via, for example, a DSA or DSC request. If the service flow already exists and has a provisioned set of QoS parameters, then a DSC request may add a second set of QoS parameters to the service flow.

A service flow is placed in the active state when it is given an active set of QoS parameters via, e.g., a DSA or DSC request. If the service flow already exists and has an admitted or provisioned set of QoS parameters, then a DSC request will create a second (or third) set of QoS parameters for the service. A DSC request must provide an active state set of QoS parameters that is the same or a subset of the admitted or provisioned set of QoS parameters. Also, provisioned and admitted sets of QoS parameters are optional. A service flow may be created via a DSA request that provides only one set of QoS parameters, the active set of QoS parameters. In this case, the service flow will be immediately activated upon successful completion of the DSA request.

### IV. The Service Level Package

As discussed above, a service level agreement between a subscriber and a multiple service operator defines the service flows provided to the subscriber. Accordingly, one initial step that a multiple system operator may take to form a differentiated set of cable data services is the creation of the service level package or “SLP” definitions that incorporate the different service level agreements the multiple system operator wishes to make available to its subscribers. These packages can then be provided to the subscriber, so that the subscriber can select the service level package having the service flows desired by the subscriber.

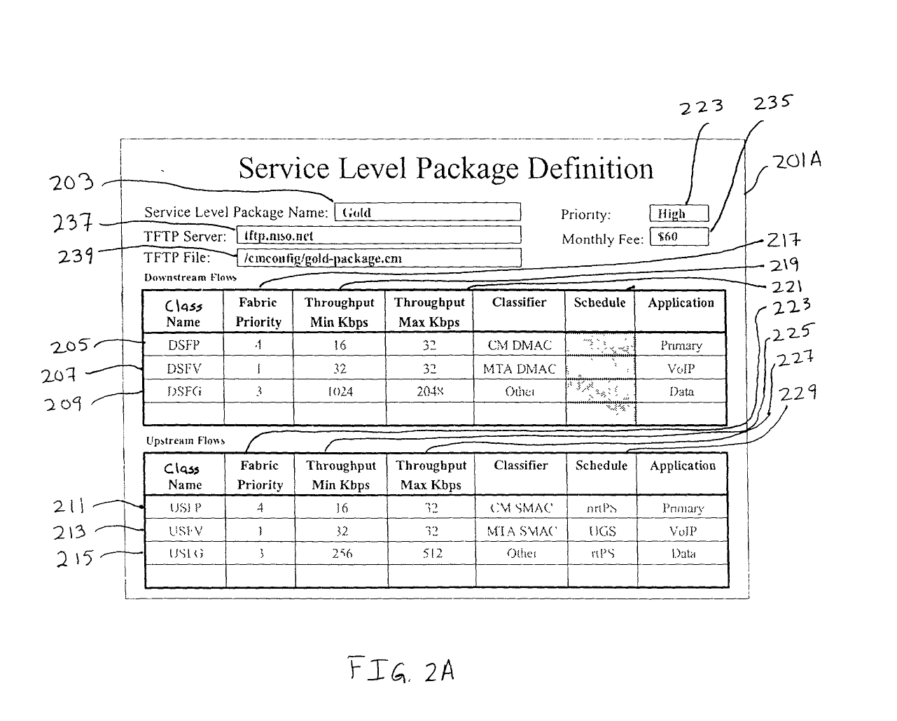

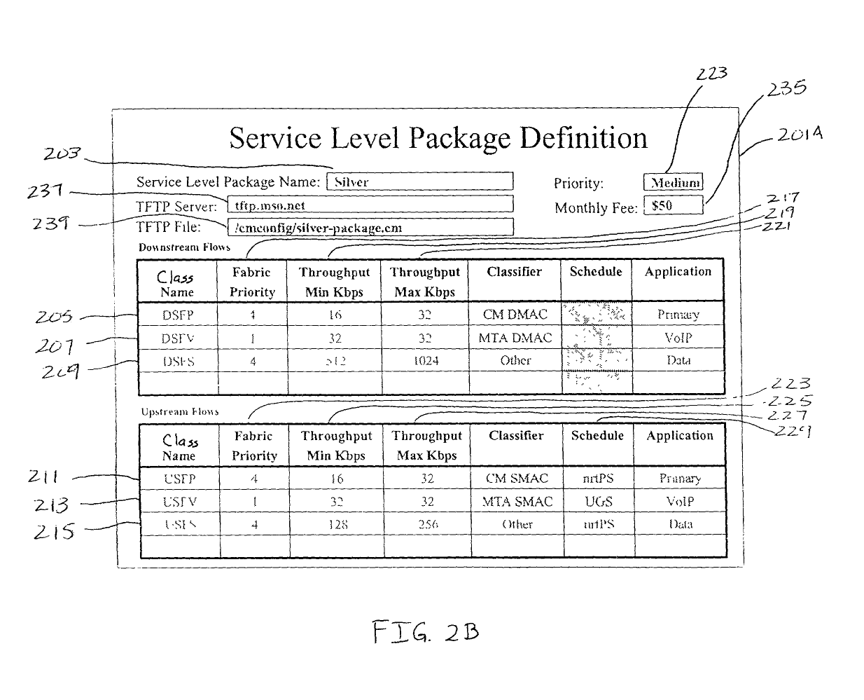

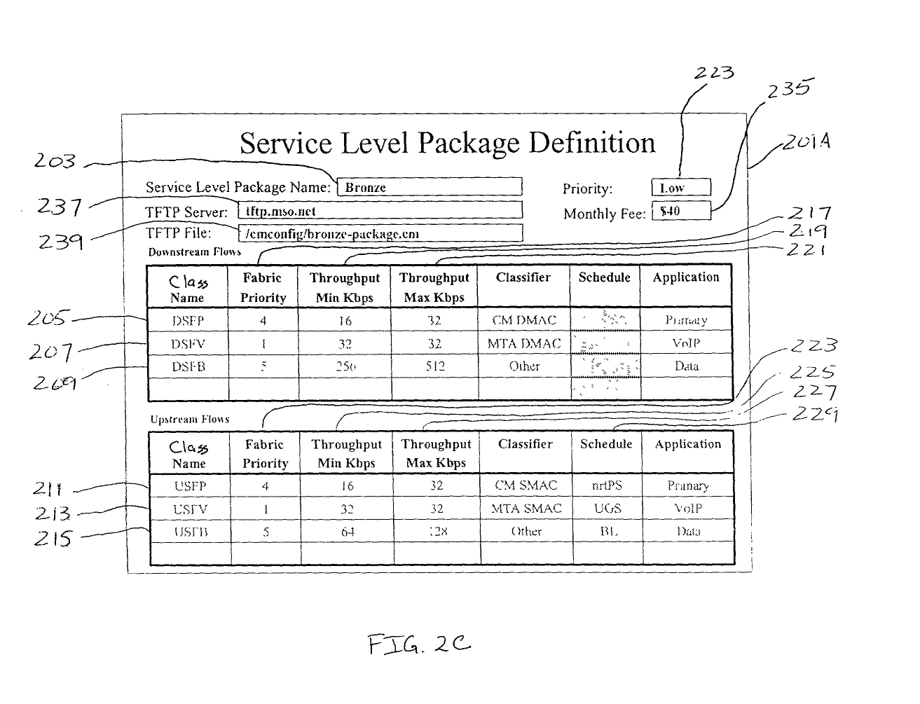

FIGS. 2A-2C show three different tables 201A, 201B, and 201C with the service flows that make up three different service level packages, respectively. As seen in these figures, a service level package name 203 can be used to conveniently identify all of the service flows 205-215 that make up the service level agreement in the service level package. These service flows 205-215 have QoS parameters 217-229, such as minimum and maximum throughput bandwidths 219, 221, 225, and 227, fabric priority 217 and 223, and upstream scheduling mode 229. The service flows 205-215 may also include packet header classifiers 231 used to associate a data packet with its service flow (such as, e.g., the MAC address of the cable modem destination or the MAC address of the mail transfer agent source). It should be noted that the service level package definitions shown in these figures include both QoS parameters that are required by the DOCSIS 1.1 standard, as well as additional QoS parameters that may be provided for by the vendor providing the cable modem termination system 107 to the multiple system operator.

In addition to the package name 203, a service level package may also have other parameters that apply to the entire package, such as a priority summary 233, and a monthly fee 235 associated with the service level package. The service level package may also have the name 237 of the TFTP server 123 on which the cable modem configuration file corresponding to the service level agreement incorporated in the package definition is stored, and the file name 239 in which cable modem configuration file is stored on the TFTP server 123.

In reviewing FIGS. 2A-2C, it should be noted that both upstream and downstream service flows are defined for each service package, and that there are common service flows among the three example service level packages. More particularly, the common service flows in these examples include the downstream service flow-primary, or “DSFP,” and the upstream service flow-primary, or “USFP.” These service flows are the primary service flows used for messages from the cable modem termination system 107 to the cable modem's MAC layer management. The common service flows in these examples also include the downstream service flow-voice over Internet protocol, or “DSFV,” and the upstream service flow-voice over Internet protocol, or “USFV.” These service flows are used for Voice over IP (VOIP) packet telephone services.

The data-bearing service flows that actually implement the differences among the service level packages are the downstream service flow-gold, or “DSFG,” and the upstream service flow-gold, or “USFG,” in the gold service level package, the downstream service flow-silver, or “DSFS,” and the upstream service flow-silver, or “USFS,” in the silver service level package, and the downstream service flow-bronze, or “DSFB,” and upstream service flow-bronze, or “USFB,” in the bronze service level package. Thus, for the above-described example, the entire set of unique service flows required to define these three exemplary service level packages is only 10 instead of 18. Of course, those of ordinary skill in the art will appreciate that the above described service level packages are presented only to provide a concrete example, and that any number of variations of service level packages can be employed according to the invention.

It should be noted that, as shown in Table 1, all of the cable modem configuration files (stored in cable modem configuration file storage 125 of the TFTP server 123) contain the parameters for all of the above 10 service flows. Within each cable modem configuration file, however, only the service flows that implement the service level package designated for the associated cable modems 109 are active, and thus only these service flows will be installed by the associated cable modem 109 and the cable modem termination system 107 when that cable modem 109 is registered. The other provisioned service flows are available in the configuration file to be activated later.

### V. Defining the Service Level Package

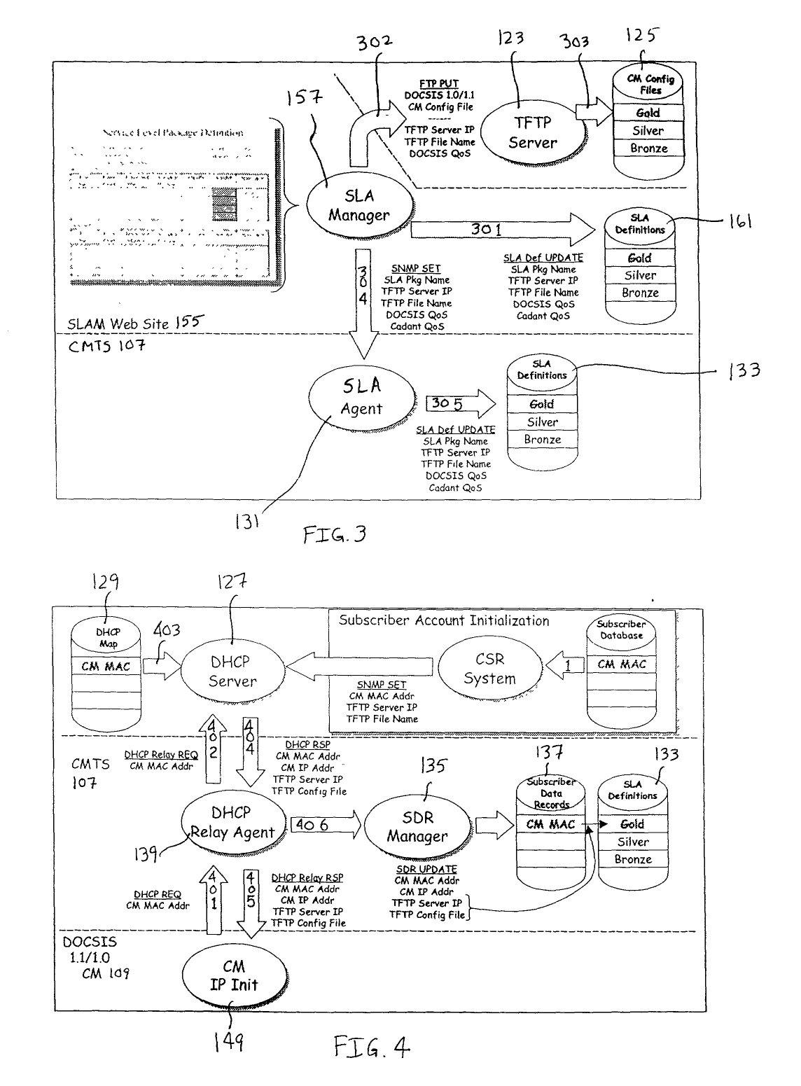

FIG. 3 illustrates the steps for defining a service level package so that it can be employed by a cable modem 109 and its associated cable modem termination system 107. This process employs the service level agreement manager application 157, which, as previously noted, is hosted by the service level agreement manager server 117. The service level agreement manager application 157 allows the multiple system operator to create and modify service level package definitions that the multiple system operator wishes to make available to its subscribers. In some preferred embodiments of the invention, the use of the service level agreement manager application 157 is restricted to the multiple system operator's personnel, and is accessible only through the operations network 103. Subscribers will not typically have access to the service level agreement manager application 157.

The service level agreement manager application 157 may initially provide a user interface, such as an HTML page displaying the tables shown in FIGS. 2A-2C, to the multiple user operator in order to obtain the service level package definitions. The multiple service operator can then use this interface to designate the service flow parameters for a service level package. For example, the multiple service operator may change some of the QoS parameters for a one of the particular service flows provided in the “Gold” package shown in FIG. 2A. After the multiple service operator has designated the service flow parameters for a service level package, the service level agreement manager application 157 prepares these definitions for use by a cable modem 109 and its associated cable modem termination system 107, as follows.

In step 301, the service level agreement manager application 157 proceeds to store the designated service level package definitions in the local service level agreement definitions storage 161 under the service level package name 203 for future reference. In step 302, the service level agreement manager application 157 constructs a DOCSIS 1.1-compliant cable modem configuration file (from a subset of the service level package information defined by the standard DOCSIS QoS parameters), which is then transmitted, to the appropriate TFTP server 123. The cable modem configuration file can be transmitted to the TFTP server 123 by, e.g., a FTP PUT operation, or any other suitable transmission operation. Once the TFTP server 123 has received the cable modem configuration file, it stores the configuration file in step 303 in its cable modem configuration file storage 125 under the given TFTP file name 239.

In step 304, the service level agreement manager application 157 also sends the designated service level package definitions to the service level agreement agent 131 in the cable modem termination system 107. The service level agreement manager application 157 can transmit this information to the service level agreement agent 131, using, for example, the SNMP SET procedure, or any other suitable transmission procedure. Next, in step 305, the service level agreement agent 131 saves the service level package definitions locally in the service level agreement definitions storage 133.

### VI. The Cable Data Service Subscription and Registration of the Cable Modem

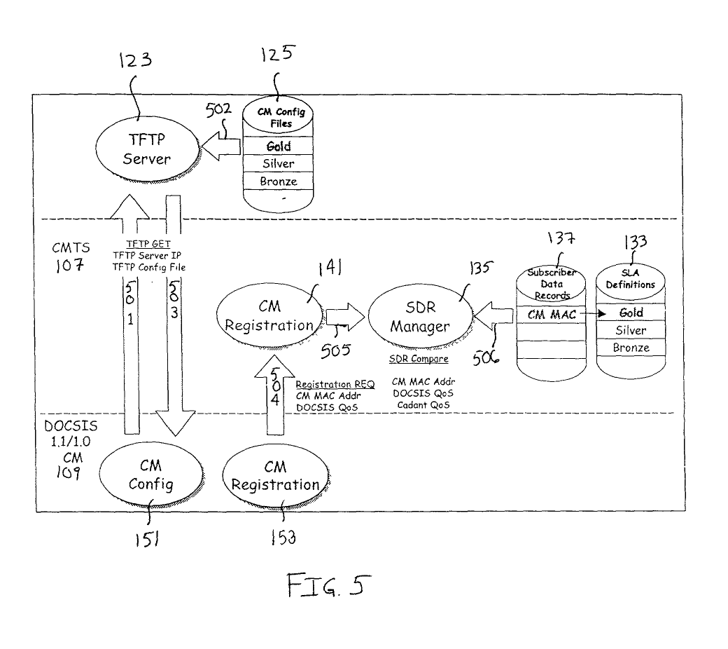

After the service level packages have been created and installed in the service level agreement management server 117, the TFTP server 123, and the cable modem termination system 107, the cable data service subscription process and the cable modem registration process shown in FIGS. 4 and 5 may begin. The cable modem registration process is well documented in the DOCSIS 1.1 Radio Frequency Interface specification.

As previously noted, the subscriber is expected to communicate with the multiple system operator via a subscription process (either automatic or manual) carried out by a customer service representative or “CSR” system 401 (not previously discussed), in order to define the business relationship between the subscriber and the multiple system operator. This typically results in the establishment of a billing account for the subscriber and the provisioning of the network resources to support the subscriber's service. In particular, the initial service level agreement between the subscriber and the multiple system operator is established at this time, and arrangements are conventionally made for the cable modem equipment to be delivered and installed on the subscriber's premises.

The specifics of the CSR system process are well known in the art and thus will not be described in detail here. For the purposes of this explanation, however, it should be noted that it results in the association between a MAC address for the cable modem 109 assigned to the subscriber and a cable modem configuration file previously installed on the TFTP server 123. This cable modem MAC address-to-cable modem configuration file association may be maintained by the DHCP server 127 in its DHCP map storage 129 (or, alternately, by another server in the cable modem manager 111), and its creation is identified in FIG. 4 by the title “Subscriber Account Initialization.” More than one cable modem 109 may be associated with a given cable modem configuration file, because more than one subscriber may have the same service level agreement. Also, given the temporal nature of IP address assignments, the subscriber can always be uniquely identified by the invariant MAC address for the subscriber's cable modem maintained in the cable modem manager 111.

Cable modem registration is the process of initializing the subscriber's cable modem with the appropriate network and QoS parameters that allow the cable modem to correctly perform its function as the bridge between the Internet 113 and the subscriber's customer premises equipment 121. Conventionally, cable modems 109 initialize and register themselves with the cable modem termination system 107 according to the DOCSIS 1.1 standard mechanisms. Only one portion of this activity is relevant to the service level agreement management process of the invention. This is the handling in the cable modem termination system 107 of the DHCP request the cable modem 109 uses to obtain its dynamically assigned IP address, as well as the identity of the TFTP server 123 and its TFTP file 239 that contains the cable modem's default cable modem configuration file. This portion of the registration process ensures that the cable modem manager 111 can associate a MAC address for cable modem 109 with the IP address for the cable modem 109 and the identity of the TFTP server 123 and its TFTP file 239 that contains the cable modem's default cable modem configuration file.

The flow of this activity is illustrated in FIG. 4. As previously noted, the cable modem termination system 107 contains a DHCP relay agent 139, as required by the DOCSIS 1.1 specification. In step 401, the DHCP relay agent 139 receives a DHCP request from the IP initialization application 149 in the cable modem 109. It then relays this request, which includes the MAC address for the cable modem 109, to the DHCP server 127 in step 402, as proscribed by the DOCSIS 1.1 standard. In step 403, the DHCP server 127 uses the received MAC address for the cable modem 109, together with the information it received from the subscription process, to obtain the relationship between the cable modem's MAC address, an IP address the DHCP server 127 assigns to the cable modem 109, and the TFTP server IP address and the TFTP server file name 239 for the cable modem configuration file associated with the cable modem 109.

Next, in step 406, the DHCP relay agent 139 forwards this relationship to the local subscriber data record manager 135. The subscriber data record manager 135 then uses this information in step 407 to update the subscriber data record in the subscriber data record storage 137 associated with the MAC address for the cable modem 109 MAC. This results in a link from the MAC address for the cable modem 109 to the service level agreement definition file for the cable modem 109 in the service level agreement definitions storage 133, via the IP address of the TFTP server 123 and the TFTP file name 239 for the cable modem configuration file stored in the in the subscriber data record storage 137.

Referring now to FIG. 5, the cable modem configuration application 151 in the cable modem 109 uses the information provided by the DHCP server 127 (i.e., the TFTP server's IP address and the TFTP file 239 storing the configuration file for the cable modem 109) in step 501 to locate the TFTP server 123 and request its cable modem configuration file. In response, the TFTP server 123 obtains the requested cable modem configuration file in step 502, and delivers the requested configuration file to the cable modem configuration application 151 in step 503. The cable modem 109 then uses the cable modem configuration file to initialize and register itself. It should be noted that the cable modem configuration file in the noted TFTP file name 239 contains only the DOCSIS standard QoS parameters.

As the cable modem 109 continues the registration process in step 504, the cable modem registration application 153 forwards a cable modem registration request with the QoS and operational parameters obtained from the TFTP file 239 to the cable modem registration application 141 in the cable modem termination system 107. In step 505, the cable modem registration application 141 of the cable modem termination system 107 forwards the MAC address for the cable modem 109, along with the DOCSIS QoS parameters, to the subscriber data record manager 135. In turn, the subscriber data record manager 135 in step 506 obtains the subscriber data record for the cable modem 109 with the linked service level agreement definition corresponding to the cable modem's MAC address. As previously noted, the service level agreement may include QoS parameters that are additional to those set forth in DOCSIS.

After the subscriber data record manager 135 has retrieved the level agreement from the service level agreement definition storage 137, it compares the DOCSIS QoS parameters received from the cable modem with the DOCSIS QoS parameters stored in the service level agreement definition storage 137. This comparison is made to determine if the cable modem 109 has been compromised, or if it has retrieved the wrong cable modem configuration file.

The customer premises equipment 121 undergoes a similar initialization process. During this process, in a manner similar to the cable modem registration process described above, the DHCP relay agent 139 obtains an IP address for the customer premises equipment 121 from the DHCP server 127. Thus, the DHCP server maintains the association between the MAC address for the customer premises equipment 121, the IP address for the customer premises equipment 121, and the MAC address for the cable modem 109. Accordingly, the cable modem manager 111 containing the DHCP server 127 can cross-reference IP addresses for both registered customer premises equipment 121 and registered cable modem 109 to the IP address for the cable modem termination system 107 associated with the customer premises equipment 121 or a cable modem 109.

### VII. Self-managed Dynamic Service Level Agreement Change Process

After a subscriber has been connected to the operations network 103 as described in the previous section, all traffic flowing between the subscriber's customer premises equipment 121 and the Internet 113 is policed by the cable modem 109 and the cable modem termination system 107 according to the service level agreement initially subscribed to by the subscriber. Even if the Internet 113 traffic is lightly loaded, a given subscriber will only be allowed to pass data at the maximum throughput and priority guaranteed by his or her service level agreement.

Accordingly, a subscriber who has subscribed to a low-performance service level agreement may wish to dynamically upgrade to a higher performance service level agreement for an additional monthly usage charge. Alternately, if a subscriber is not using the maximum capacity of his or her service level agreement, the subscriber may want to dynamically downgrade to a lower performance service level agreement for a reduction in the monthly service charge. The service level agreement management Web site 117 according to the invention provides a convenient way for subscribers to dynamically change their service level agreements without intervention by the customer service representative system.

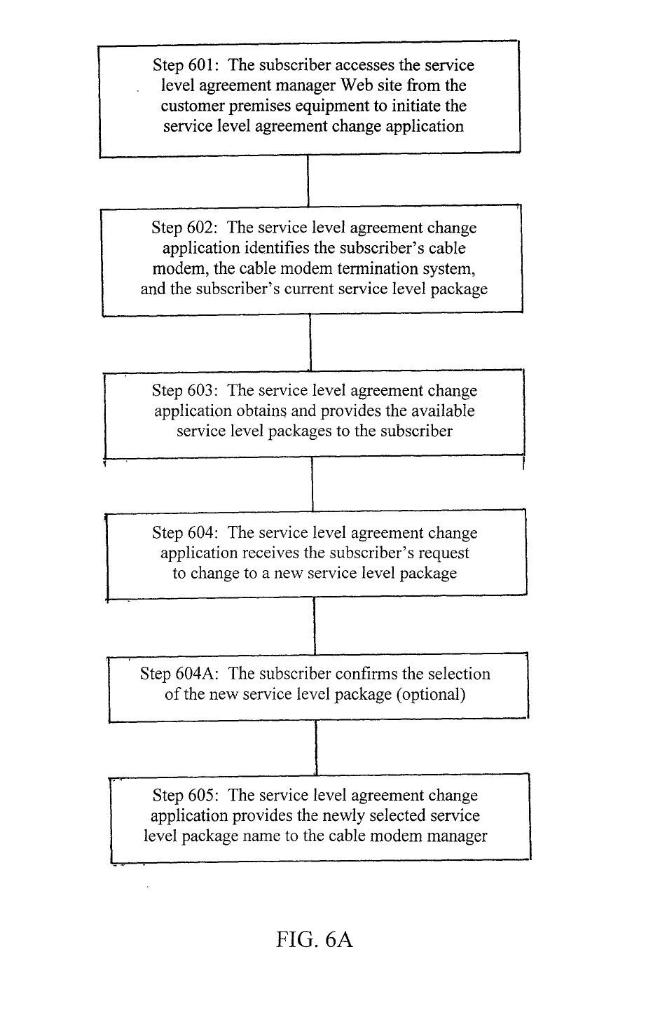

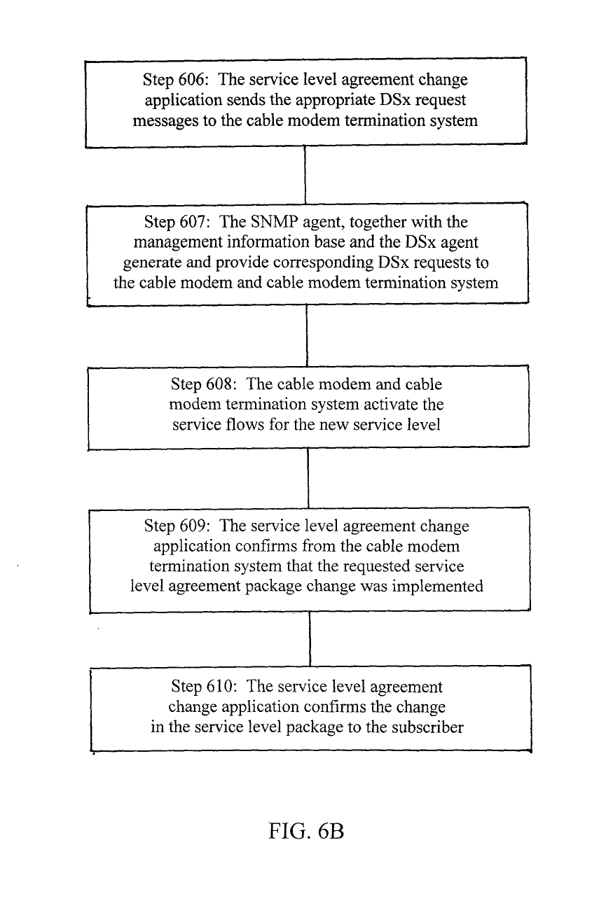

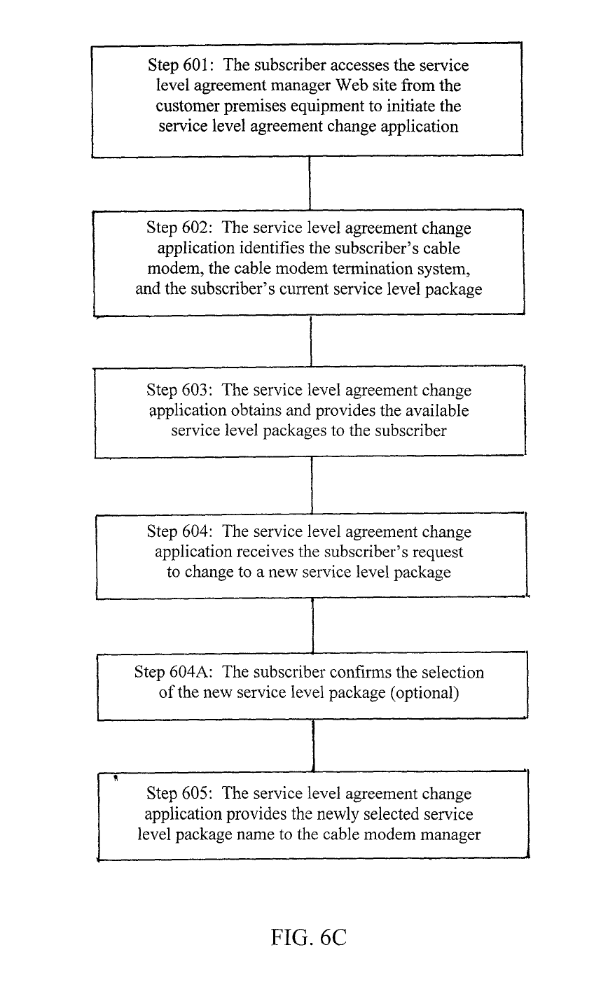

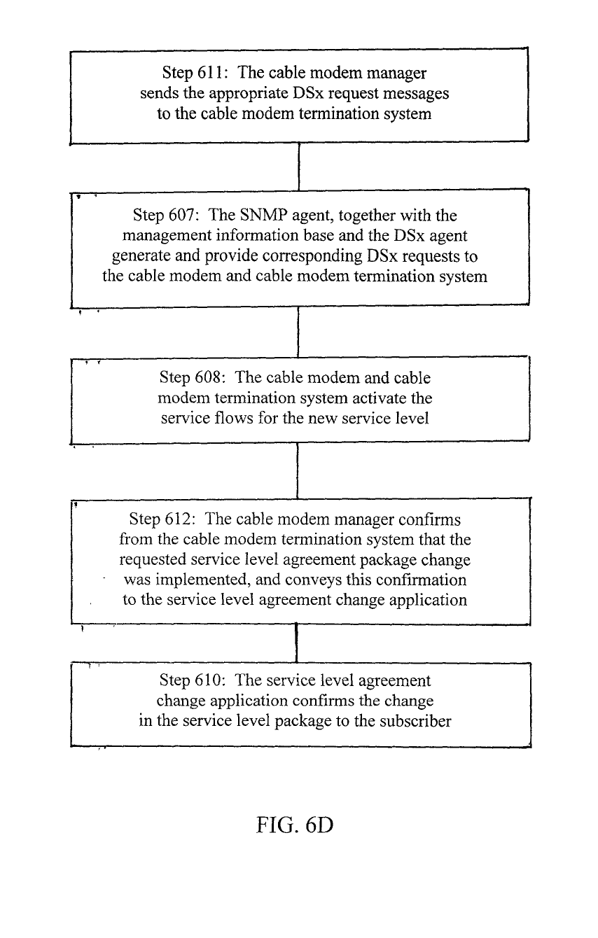

Referring now to FIGS. 6A and 6B, to initiate the dynamic service level change procedure according to the invention, the subscriber first accesses the service level agreement manager Web site 155 from his or her customer premises equipment 121 in step 601. The subscriber may access the service level agreement manager Web site 155 using a conventional Web browser, such as Microsoft's Internet Explorer or Netscape Navigator. Also, the subscriber may obtain a URL for the service level agreement manager Web site 155 from, for example, a home page maintained by the multiple service operator.

Once the subscriber has accessed the service level agreement manager Web site 155, he or she invokes the service level agreement change application 159. As is known in the art, the subscriber can invoke the service level agreement change application 159 with, for example, an HTTP GET request. From this invocation, the standard CGI application interface for the service level agreement manager Web site 155 obtains the the IP address of the subscriber's customer premises equipment 121 for the service level agreement change application 159. As will be appreciated by those of ordinary skill in the art, however, information regarding the subscriber's cable modem 109 is not visible to the service level agreement manager Web site 155 from this interface.

Accordingly, in step 602, the service level agreement change application 159 contacts the cable modem manager 111 to obtain the relationship between the IP address for the customer premises equipment 121, the MAC address for the subscriber's cable modem 109, the IP address for its cable modem termination system 107, and the current service level package name 203 being used by the subscriber's cable modem 109. Thus, the service level agreement change application 159 identifies the subscriber's cable modem 109, its associated cable modem termination system 107, and the subscriber's current service level package 203.

In step 603, the service level agreement change application 159 accesses its local service level definitions storage to retrieve all of the service level package definitions available to the subscriber, including the service level package corresponding to the subscriber's current service level package name 203. Alternately, the service level agreement change application 159 may retrieve all of the service level package definitions available to the subscriber from the cable modem manager 111 associated with the subscriber's cable modem. (With this alternate embodiment, the service level manager 157 may omit pre-storing the available service level package definitions in the service level agreement definitions storage 161 described in the step 301 of FIG. 3.)

After the service level agreement change application 159 has retrieved all of the service level package definitions available to the subscriber, it provides these service level packages to the subscriber so that the subscriber may select a new service level package. For example, the service level agreement change application 159 may deliver the dynamic HTML request service level agreement change page 701, shown in FIG. 7, to the subscriber's Web browser via, e.g., a HTTP response.

As seen in FIG. 7, the dynamic HTML request service level agreement change page 701 displays all of the available service level packages in a table 703, particularly identifying the subscriber's current service level package. In the illustrated example, the subscriber's current service level package is Bronze and the available service level packages are Silver and Gold. According to some preferred embodiments of the invention, the subscriber can use just this page 701 to submit a request to change to a new service level package, by, e.g., simply by activating a link on the page 701 associated with the desired new service level package.

For example, in the change page 701 shown in FIG. 7, the portion of the table 703 corresponding to the subscriber's current service level package (i.e., Bronze) does not have an active link, while the portions of the table corresponding to the available service level packages (i.e., Gold and Silver) contains active links 705 and 707 entitled “Silver Package” and “Gold Package,” respectively. The subscriber can thus request a change in service from the Bronze service level package to the Gold service level package simply by activating link 707.

Returning now to FIG. 6, in step 604, the service level agreement change application 159 receives the subscriber's request to change to a new service level package. After receiving the subscriber's request, the service level agreement change application 159 may optionally have the subscriber confirm the selection of the new service level package in step 604A.

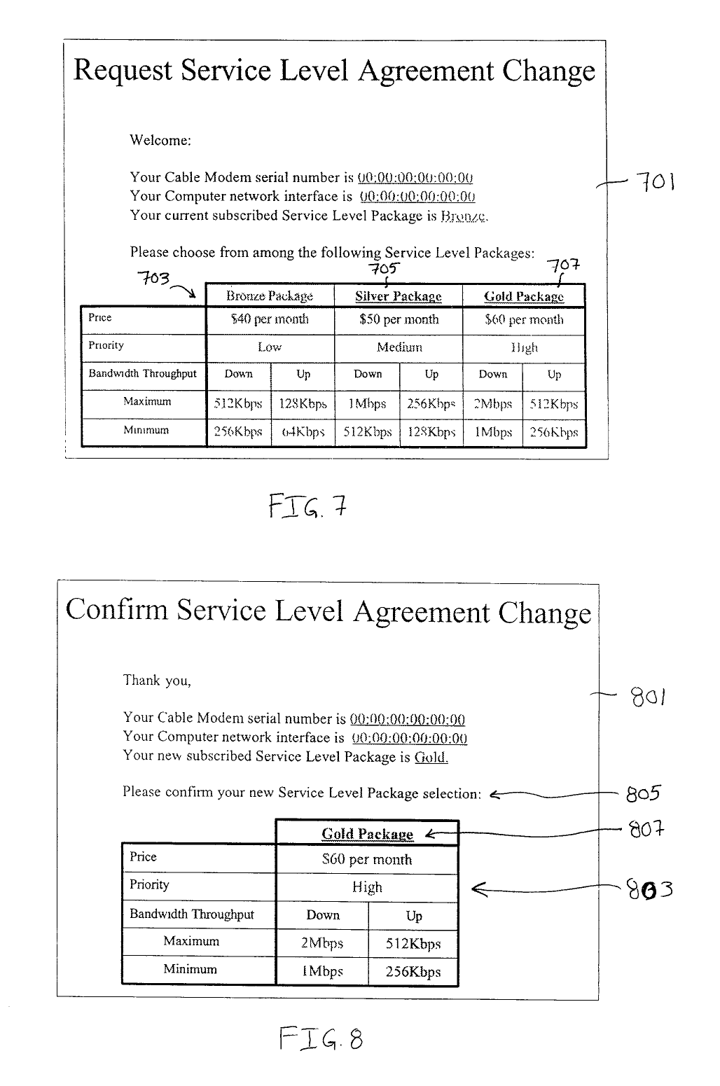

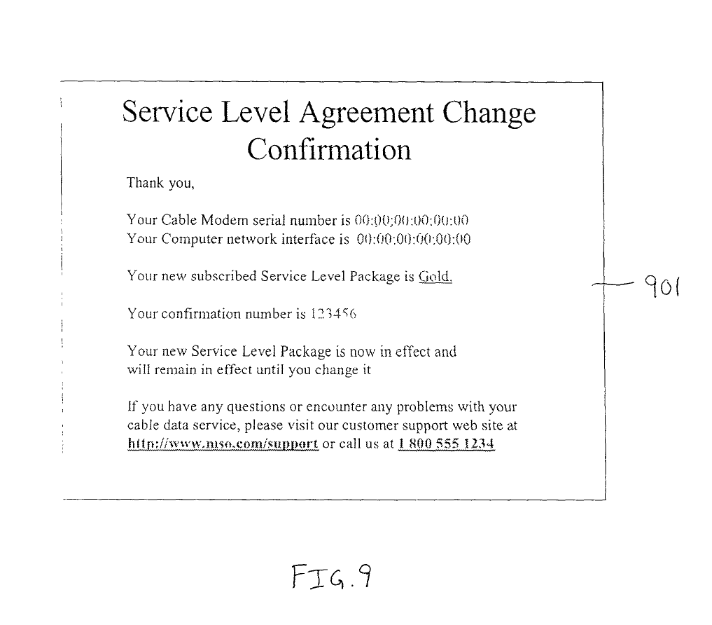

For example, the service level agreement change application 159 may provide the subscriber with the HTML confirm service level agreement change page 801 shown in FIG. 8. As seen in this figure, the page 801 includes a table 803 setting forth the characteristics of the newly requested service level agreement package, along with a prompt 805 asking the subscriber to confirm the requested change in the service level agreement package. In the illustrated example, the subscriber has selected the Gold service level package. The subscriber may then conveniently confirm the requested change to the service level agreement change application 159 by, for example, activating a link 807 corresponding to the requested service level agreement package.

After the subscriber has selected a new service level package (or, optionally, confirmed the selection of a new service level package), the service level agreement change application 159 provides the service level package name 239 of the newly selected service level package to the DHCP server 127 of the cable modem manager 111 in step 605. The new service level package name can be transmitted to the DHCP server 127 using, for example, a SNMP SET operation. The DHCP server 127 then updates the DHCP map storage 129 with the new service level package name 239. This ensures that the cable modem 109 will use the cable modem configuration file corresponding to the new service level package when it reboots.

In step 606, the service level agreement change application 159 also sends the appropriate DSx request messages (corresponding to the newly selected service level package) to the cable modem termination system 107. It should be noted that these request messages may specify the characteristics that define a DSx request (i.e., the service flow parameters that will be created, changed or modified by the DSx request). For example, the DSx request messages may include specific packet classifiers, QoS parameters, or payload header suppression rules for the service flows in the newly selected service level package. Further, the request messages may refer to particular service flows already provisioned in the cable modem termination system 107 using their names (i.e., the service class names for the service flows). The DSx request messages may be sent to the cable modem termination system 107 using, e.g., the SNMP SET operation.

As will be described in detail below, these request messages to the cable modem termination system 107 prompt the SNMP agent 145, together with the management information base 147 and the DSx agent 143 to generate and provide corresponding DSx requests in step 607 to the cable modem 109 and the cable modem termination system 107. In step 608, both the cable modem 109 and the cable modem termination system 107 respond to the DSx requests by activating the service flows for the newly selected service level package.

An appropriate time after sending the DSx request messages to the cable modem termination system 107, the service level agreement change application 159 checks back with the cable modem termination system 107 in step 609, to confirm that the requested service level agreement package change was implemented. More particularly, the service level agreement change application 159 requests DSx responses from the cable modem termination system 107 using, for example, a SNMP GET operation. If the DSx responses indicate that the service level change was properly implemented, then the service level agreement change application 159 may confirm the change in the service level package to the subscriber in step 610.

For example, the service level agreement change application 159 may provide the subscriber with the HTML service level agreement change confirmation Web page 901 shown in FIG. 9. As seen in that figure, the page 901 identifies the new service level package now being used by the cable modem 109. It may also include additional information useful to the subscriber such as, e.g., the serial number for the cable modem 109, a confirmation number for the executed service level package change, a telephone number to obtain additional assistance from the multiple service operator, etc.

This completes the operation of the service level agreement change application 159. The subscriber's data traffic will immediately receive the new service level treatment without disruption of the cable modem or the subscriber's network connection. This new service level agreement will remain in effect until the subscriber (or the customer service representative system acting on behalf of the subscriber) changes it again.

An alternate embodiment of the invention is shown in FIGS. 6C and 6D. As seen in these figures, this alternate embodiment performs steps 601-605, 607, 608 and 610 as described above. Instead of the service level agreement change application 159 providing the DSx request messages to the cable modem termination system 107 in step 606, however, the cable modem manager 111 (already having received the name 203 of the newly selected service level agreement) provides the DSx request messages to the cable modem termination system 107 in step 611. Then, in step 612, the cable modem manager checks back with the cable modem termination system 107 to confirm that the requested service level agreement package change was implemented. It then passes this confirmation on to the service level agreement change application 159, so that the service level agreement change application 159 can relay this confirmation to the subscriber in step 610. Alternately, the cable modem manager 111 may deliver the confirmation directly to the subscriber.

Those of ordinary skill in the art will appreciate that a variety of other embodiments are possible as well. For example, with the second embodiment discussed above, if the multiple service operator makes the same service level packages available to all subscribers, then the service level agreement change application 159 can omit identifying the identifies the subscriber's cable modem, its cable modem termination system, and the subscriber's current service level package in step 602. Instead, the service level agreement change application 159 can provide the IP address for the customer premises equipment to the cable modem manager with the name of the new service level package in step 605.

Also, as described above, the service level agreement change application 159 begins the dynamic service level change process by employing the cable modem manager to cross-reference the IP address for the subscriber's customer premises equipment 121 with the MAC address for the cable modem 109, the IP address for the cable modem termination system 107, and the current service level package name 203 that the cable modem 109. Other embodiments of the invention, however, may use alternate or additional criteria can to cross-reference this information. For example, the subscriber may obtain a personal identification number or “PIN” from the CSR system 401. The PIN can then be used to cross reference information in the cable modem manager 111. This conveniently allows a subscriber to change his or her service level agreement without using his or her customer premises equipment 121.

Further, with some embodiments of the invention, the multiple system operator's billing system may be notified of the change in the service level package, so that it can later note that there are billing usage counts for this subscriber associated with the new service level package name, and prorate the monthly bill accordingly. If the subscriber changes back to the original service level package, then the billing counts for the original service level package may begin to be incremented again as well.

### VIII. On-demand Dynamic Service Level Agreement Change Process

The above-described embodiment of the invention conveniently allows a subscriber to dynamically change his or her default service level agreement package to a new service level agreement package. A subscriber can thus upgrade to a higher service level agreement package in order to, for example, receive content from the third party content server 119 with a greater bandwidth than that ordinarily used by the subscriber. The process of dynamically changing the service level may become tedious, however, if the subscriber changes his or her service level package every time he or she seeks to download large amounts of content from a content server. Also, the subscriber may not be able to easily determine the appropriate service level agreement package to most efficiently receive the content.

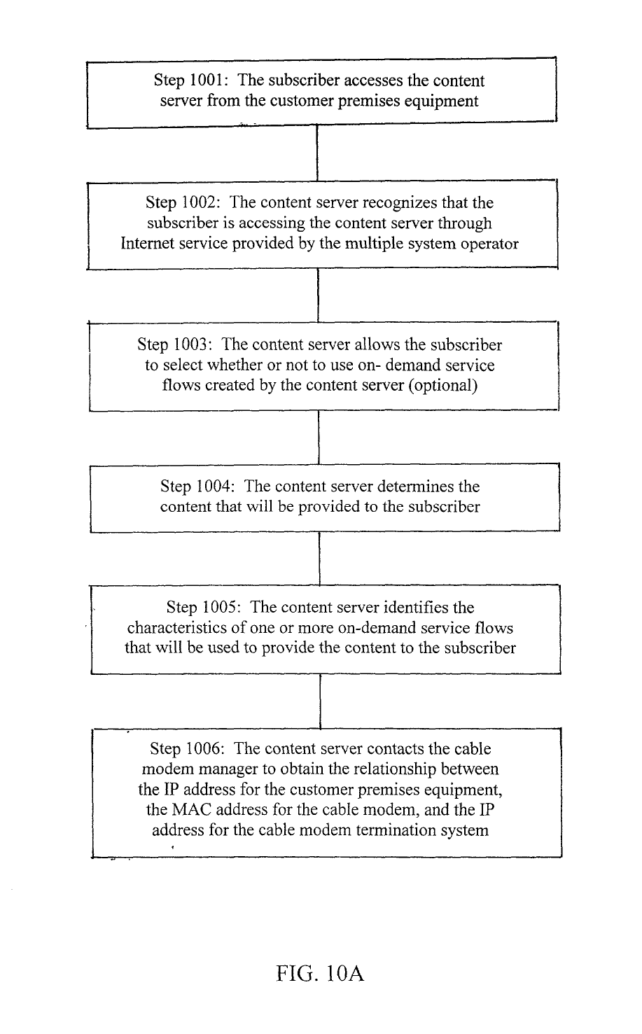

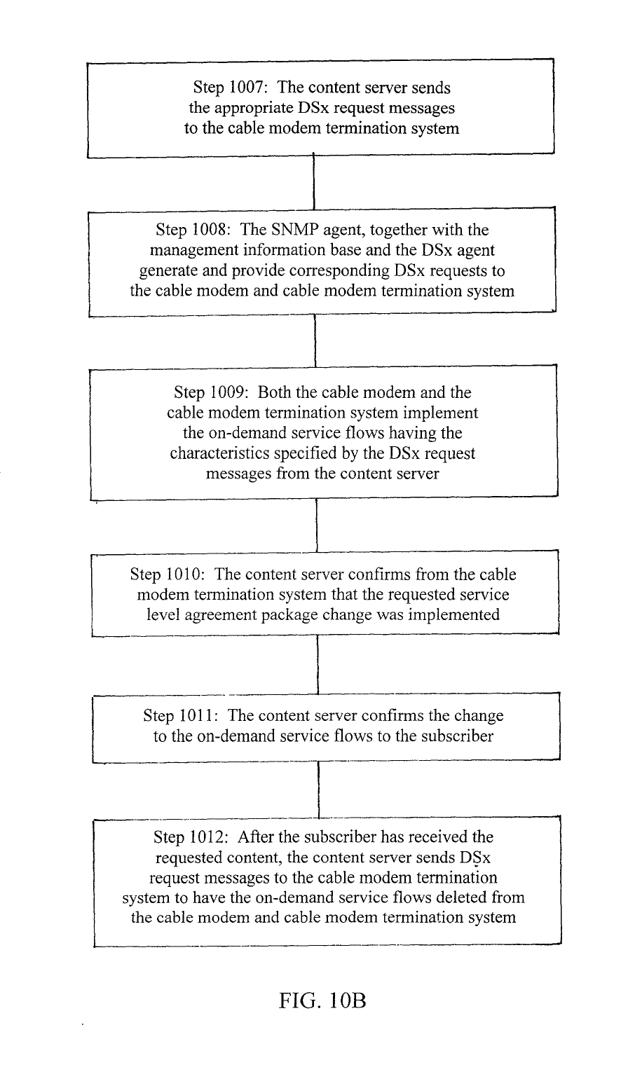

Accordingly, as will be described below with reference to FIG. 10, another embodiment of the invention allows a subscriber to obtain on-demand service flows that are used only while the subscriber is downloading content from the content server 119. Further, the embodiments of the invention allow the third party content server 119 to automatically designate the service flows for the subscriber, so that the content server 119 can optimize the on-demand service flows for downloading the content.

With this embodiment of the invention, the subscriber accesses the content server 119 from his or her customer premises equipment 121 in step 1001, in order to obtain content through the content server 119 (i.e., either from the content server 1119, or from a another content server associated with content server 119). As is conventional, the subscriber may access the content server 119 using a Web browser, such as Microsoft's Internet Explorer or Netscape Navigator. By accessing the content server 119 from the customer premises equipment 121, the subscriber provides the content server 119 with the IP address of the subscriber's customer premises equipment 121.

In response, the content server 119 recognizes in step 1002 that the subscriber is accessing it through Internet service provided by the multiple system operator. As will be appreciated by those of ordinary skill in the art, this recognition can be implemented in a number of different ways. For example, the subscriber may access the content server 119 through a URL or link provided exclusively at a Web page maintained by the multiple system operator. Alternately, the cable modem manager 111 may continuously update the content server 119 with IP addresses for customer premises equipment 121 of the multiple system operator's current subscribers. Still further, the subscriber may provide the content server 119 with a code or password identifying the subscriber as someone accessing the content server 119 via Internet service provided by the multiple system operator.

In step 1003, the content server 113 may optionally allow the subscriber to select whether or not to use on-demand service flows created by the content server 119. For example, the content server 119 may provide the subscriber's Web browser with an HTML page containing one or more links to accept (or decline to accept) on-demand service flows created by the content server 119. Alternately, the content server 119 may omit this step and automatically change the subscriber's service to use on-demand service flows created by the content server 119.

Next, in step 1004, the content server 119 determines the content that will be provided to the subscriber. This step may require a specific action from the subscriber, such as activating link in a HTML Web page identifying the desired content. Alternately, this step may be incorporated into step 1001 above. For example, the subscriber may access the content server 119 using a URL that inherently identifies the content the subscriber wishes to obtain from the content server 119.

In step 1005, the content server 119 identifies the characteristics of one or more on-demand service flows that will be used to provide the content to the subscriber. Typically, the content server 119 will associate both a bandwidth and an IP address for a content server with the content requested by the subscriber. (As previously noted, a content server other than the content server 119 may actually provide the requested content to the subscriber.) For example, if the requested content is a movie, the content server 119 may associate a very high bandwidth with that content. The content server 119 may also identify a user datagram protocol or “UDP” port address associated with the requested content, or a transmission control protocol or “TCP” port address associated with the requested content.

The identified bandwidth may be used as QoS parameter for the new on-demand service flows, while the identified IP, UDP port and TCP port addresses may be used to create the packet classifier for data packets belonging to the on-demand service flows. Alternately, the content server 119 may identify a service class name for an existing service flow associated with the requested content, instead of an individual bandwidth.

In step 1006, the content server 119 contacts the cable modem manager to obtain the relationship between the IP address for the customer premises equipment 121, the MAC address for the cable modem 109, and the IP address for the cable modem termination system 107. This information can be requested from the cable modem manager 111 using a similar process as that described for step 602 above.

Having thus identified the subscriber's cable modem 109 and its cable modem termination system 107, the content server 119 sends DSx request messages to the cable modem termination system 107 in step 1007, in order to implement the on-demand service flows associated with the content requested by the subscriber. These DSx request messages specify the particular characteristics identified by the content server 119 for the on-demand service flows to be created by the cable modem termination system 107.

As in step 607 discussed above, the DSx request messages from the content server 119 prompt the SNMP agent 145, together with the management information base 147 and the DSx agent 143 to generate and provide corresponding DSx requests in step 1008 to the cable modem 109 and the cable modem termination system 107. In reply, both the cable modem 109 and the cable modem termination system 107 implement the on-demand service flows having the characteristics specified by the DSx request messages from the content server 119 in step 1009.

As with the previous embodiments, after sending the DSx request messages to the cable modem termination system 107, in step 1010, the content server 119 checks back with the cable modem termination system 107 after an appropriate time, to confirm that new on-demand service flows were properly implemented. Like step 609 discussed above, the content server 119 requests DSx responses from the cable modem termination system 107. If the DSx responses indicate that the service level change was properly implemented, then the content server 119 confirms the change in the service level package to the subscriber in step 1011.

Lastly, after the content server 119 has completed providing the requested content to the subscriber, the content server 119 recognizes that the need for the on-demand service has ended. Accordingly, in step 1012, the content server 119 sends the necessary DSx request messages to the cable modem termination system 107 to have the on-demand service flow deleted from the cable modem 109 and the cable modem termination system 107.

Again, those of ordinary skill in the art will appreciate that a number of variations of the above embodiment are possible. For example, while the above steps were described in one particular order above, various embodiments of the invention may perform these steps in different orders. Also, with other embodiments of the invention, the service level agreement manager Web site 155 can be employed as an intermediary to contact the content server 119, obtain the service flow characteristics, and/or deliver the service flow characteristics in DSx request messages to the cable modem termination system 107.

### IX. Creation, Modification and Deletion of Service Flows Between the Cable Modem and the Cable Modem Termination System

In the previously discussed embodiments, the cable modem termination system 107 receives DSx request messages from the service level agreement change application 159, the cable modem manager 11 or the content server 119, in order to modify the service flows between the cable modem 109 and the cable modem termination system 107. (For convenience, each of these DSx request message sources will generically be referred to as a DSx application hereafter.) After receiving these DSx request messages, the cable modem termination system 107 must then prepare and forward the appropriate DSx requests to the cable modem 109, so that the cable modem 109 can effect the desired service changes.

As previously noted, the DOCSIS 1.1 specification addresses both the definition of service flows and a dynamic mechanism for managing changes of service flows between the cable modem 109 and its associated cable modem termination system 107. More particularly, the model for DOCSIS 1.1 service flows (both pre-configured and dynamic) is described in the RFI Specification (SP-RFIv1.1-I05-000714) in Chapter 8 “Quality of Service and Fragmentation”. The model for cable modem 109 to cable modem termination system 107 communications to manage changes of service flows is described in Chapter 9 “Cable Modem—CMTS Interaction”. The supporting details for the cable modem 109 to cable modem termination system 107 management communications are then provided in Appendix C “Common Radio Frequency Interface Encodings”, Appendix D “CM Configuration Interface Specification”, and Appendix J “Error Codes and Messages”.

The DOCSIS 1.1 Operations Support Systems Interface specification, or “OSSI” specification (SP-OSSIv1.1-I02-000714), identifies a management information base that supports service flow management, referred to as DOCS-QOS-MIB, which is defined in “draft-ietf-ipcdn-qos-mib-04.txt”. This DOCSIS management information base allows an application to retrieve information about service flows known to the cable modem termination system 107, but aside from the provisioning of service class names or “SCNs”, all other service flow information is employed by this management information base on a read-only basis. It is not possible to create, modify, or delete service flows via the DOCSIS management information base.

Accordingly, the management information base 147 according to various embodiments of the invention provides a mechanism for creating, modifying, or deleting service flows in the interface between the cable modem 109 and the cable modem termination system 107 by communicating with the cable modem termination system 107 exclusively. The management information base 147 allows the DSx application designating a change in the service flows to exactly specify the characteristics of the DSx messages generated in the cable modem termination system 107.

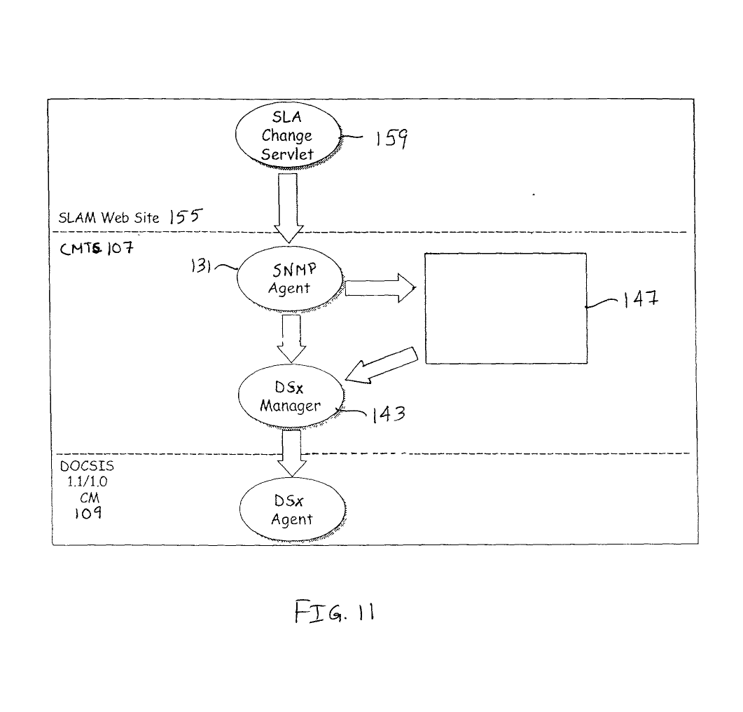

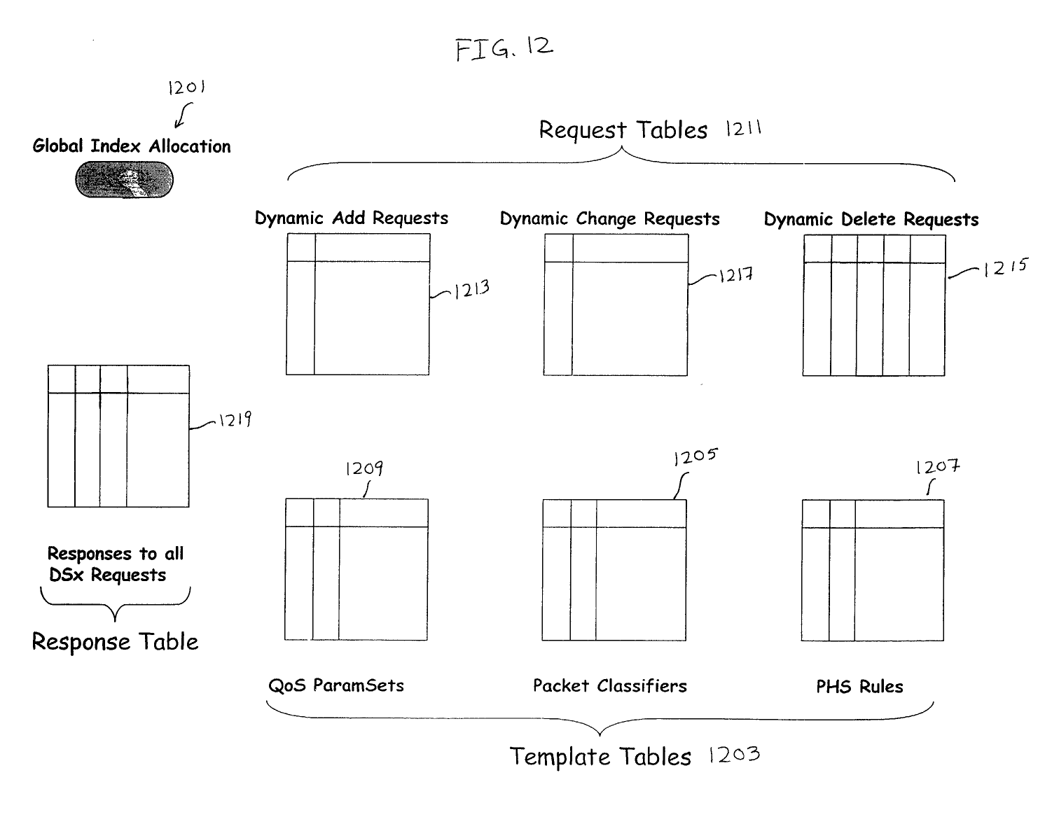

Referring now to FIG. 11, the management information base 147 cooperates with an SNMP agent 145 and a DSx manager 143. As seen in this figure, the SNMP agent 145 receives DSx request messages from DSx application 1101 that include criteria for defining a DSx request. This criteria may be characteristics of a desired service flow. The SNMP agent 145 assigns these criteria to various locations within the management information base 147. In addition, the SNMP agent 145 may pass select criteria (i.e., identifiers identifying a particular DSx request) onto the DSx manager 143.

The construction and operation of both SNMP agents and DSx managers 143 are well known in the art. In the present invention, the DSx agent needs to obtain characteristics from the management information base 147 to construct a DSx request to create, modify or delete service flows with those characteristics. Implementing this functionality with a conventional DSx agent would be well within the ordinary skill in the art after a review of the teachings herein, and thus will not be described in detail.

As will be understood in detail from the following description, the management information base 147 employs a number of different template tables, each being associated with a different type of characteristic for a DSx protocol request. The management information base 147 also employs a number of different request tables, each being associated with a different type of DSx protocol request.

In order to define a DSx request, the SNMP agent 145 assigns each characteristic received from the DSx application initiating the request to a characteristic field in an entry of the appropriate template table. The SNMP agent 145 also creates an entry in the request table corresponding to the type of DSx request being defined. This entry in the request table containers identifier fields with identifier that identify corresponding entries in the template tables that contain characteristics to be used in defining the DSx request.

When the DSx application sends a DSx request message indicating that a particular DSx request definition should be activated into a DSx request, the SNMP agent 145 updates a status field in the request table entry corresponding to the DSx request to “active.” It also passes a pointer referencing this entry in the request table to the DSx manager 143. Using this pointer, the DSx manager 143 obtains the identifiers in the entry of the request table corresponding to the DSx request. With these identifiers, it then also obtains the characteristics from the different template table entries identified by the identifiers. The DSx manager then uses the retrieved characteristics to generate a DSx request. can then be linked together using identifiers (corresponding to the DSx request) in the request table that identify each characteristic in the template tables that are to be included in the request.

Accordingly, the management information base 147 according to the invention offers a convenient mechanism by which a DSx application can define the characteristics of a DSx request. Further, by employing request tables with multiple entries, the management information base 147 can simultaneously define several different DSx requests for multiple DSx applications. Additionally, the use of template tables with multiple entries allows the management information base 147 to define DSx requests that produce a single service flow giving different QoS treatment and/or payload header suppression rules for different packet classifiers.

Referring now to FIG. 12, the management information base 147 includes a global object 1201 used to allocate unique DSx request identifiers (hereafter referred to as “RequestIDs”) in response to DSx request messages from multiple DSx applications. For example, the allocator may issue a first RequestID to a content server 119 initiating a DSx request for the creation of a new on-demand service flow, and a second RequestID to the cable modem manager 111 initiating a DSx request to change an existing service flow. The allocated RequestID is used as the primary index or identifier for all of the tables discussed below.

As previously noted, the management information base 147 employs a number of template tables 1203. These tables 1203 allow an application initiating a DSx request to designate the characteristics of the request. While the allocated RequestID serves as the primary index of all of these tables, the template tables may also have secondary indexes. These secondary indexes are sequence numbers that are managed locally by the DSx application initiating the DSx request.

The first template table, the packet classifier table 1205, is used to define the packet classifiers that select the service flow being created or modified by a DSA or DSC request. Each entry in this table includes the following fields: DsxPktClassRef, DsxPktClassSeq, DsxPktClassStatus, DsxPktClassDirection, DsxPktClassId, DsxPktClassChgAction, and DsxPktClassPriority. Each entry may also include any number of classifier characteristic fields for containing specific packet classifier characteristics, such as an IP address of the data packet's source location, an IP address of the data packet's destination location, a MAC address of the data packet's source location, a MAC address of the data packet's destination location, a port name for the data packet's source port, the priority of evaluation of each classifier in the packet, the low and high values of a range of TOS byte values, a mask value to be bitwise logically ANDed with a TOS byte in an IP packet, an IP protocol value, an indicator of which bits in an IP source address are to be employed as a classifier, an indicator of which bits in an IP destination address are to be employed as a classifier, the high and low end inclusive ranges of TCP/UDP source port numbers and destination port numbers to be employed as a classifier, etc. The DsxPktClassRef field in an entry contains a value that associates that entry with a particular DSx request. The DsxPktClassSeq field in an entry indicates whether that entry is one of several entries associated with a particular DSx request and, if it is, its sequence in the association (i.e., the first associated entry, the second associated entry, etc.)

The DsxPktClassStatus field indicates the status of the entry, and is used to create, activate, or delete the entry. If all of the packet classifier characteristics for the DSx request are provided by the same DSx request message, then DSx request message sets the value of this field to “Create And Go.” This results in the cable modem termination system 107 subsequently setting the value of this field to “active” to generate the associated DSx request. If the DSx application is using multiple DSx request messages to define all of the packet classifier characteristics in this entry, then it sets the value of this field to “Create And Wait” with the first DSx request message and then to “Active” by the last required DSx request message. If the table entry is going to be modified prior to reuse for another DSx request, the DSx application sets the value of this field to “Not In Service.” When the table entry is no longer needed, this value is set to “Destroy.”

The DsxPktClassDirection field defines the flow direction to which the classifier characteristics in the entry are being application, while the DsxPktClassId field and DsxPktClassChgAction are used only to define DSC requests. The DsxPktClassId field defines the existing packet classifier that is to be changed by the DSC request, while the DsxPktClassChgAction defines the type of change to be made to the existing packet classifier (i.e., add a new classifier, change an existing classifier, or delete an existing classifier). The DsxPktClassPriority field then defines the order of evaluation of the packet classifiers.

The payload header suppression table 1207 defines payload header suppression rules that may optionally be associated with particular packet classifiers. The entries in this table use the same index and sequence numbers as their associated packet classifiers in the packet classifier table 1205. Each entry in the payload header suppression table table 120 has the following fields: DSxPHSRef, DSxPHSSeq, DSxPHSStatus, DSxPHSDirection, DSxPHSPktClassId, DSxPHSChgAction, DSxPHSField, DSxPHSMask, DSxPHSSize, and DSxPHSVerify.

The DSxPHSRef, DSxPHSSeq, DSxPHSStatus, DSxPHSDirection, DSxPHSPktClassId, and DSxPHSChgAction fields correspond to the DsxPktClassRef, DsxPktClassSeq, DsxPktClassStatus, DsxPktClassDirection, DsxPktClassId, and DsxPktClassChgAction, respectively, described with reference to the packet classifier table 1203 above, and thus will not be discussed in detail. The DSxPHSField field is a PHS rule characteristic field that defines the bytes of the header that are to be suppressed and restored, while the DSxPHSMask is a PHS rule characteristic field that defines the bit mask that indicates which bytes of the header that are to be suppressed and restored. The DSxPHSSize field is also a PHS rule characteristic field that defines the number of bytes of the header that are to be suppressed and restored, and the DSxPHSVerify field is a PHS rule characteristic field that defines the payload header suppression verification value.

The QoS ParamSets table 1209 is a QoS parameter table that stores the QoS parameters to be included in a DSA or DSC request. Each entry in the table defines the QoS Parameters for a service flow in a given state (i.e., active or admitted), and a DSA or DSC request may combine a sequence of up to two QoS ParamSets table 1209 entries. An entry in the QoS ParamSets table 1209 includes the following fields: DsxServFlowQoSRef, DsxServFlowQoSSeq, DsxServFlowQoSStatus, DsxServFlowQoSDirection. These fields correspond to the DsxPktClassRef, DsxPktClassSeq, DsxPktClassStatus, DsxPktClassDirection, DsxPktClassId, and DsxPktClassChgAction fields, respectively, described with reference to the packet classifier table 1203 above, and thus will not be discussed in detail.

Each entry will also have a field DsxServiceFlowQosParamSetType. This field defines the QoS parameter set operation to be performed for a DSA or DSC request. For a DSC request, if the value of this field is null, then the request sets the active and admitted QoS parameters of the target service flow to null. If the value of this field is set to “active,” then the DSA or DSC request checks the associated QoS parameters against the admitted set, performs admission control if needed, and applies the associated QoS parameters to the target service flow as “active.” If the value of this field is set to “admitted,” then the DSA or DSC performs admission control and applies the associated QoS parameters to the target service flow as “admitted.” Lastly, if the value of this field is “Active And Admitted,” the then the DSA or DSC request performs admission control, and applies the associated QoS parameters to the target service flow as both “active” and “admitted.”

Of course, each entry may also include any number of QoS parameter characteristic fields for containing specific QoS parameter characteristics, such as maximum or minimum throughput (Tmax, Tmin), priority, latency, scheduling type, service class name, etc,

The management information base 147 also includes a number of request tables 1211 that are used to define DSx requests to the cable modem 109. The dynamic service add request table 1213 is used to define a DSA request. Each entry in the table contains the following fields: DSAReqCmMac, DSAReqId, DSAReqStatus, DSAReqDirection, DSAReqServFlowQosRef, DSAReqServFlowQoSCount, DSAReqPktClassRef, DSAReqPktClassCount, and DSAReqPHSCount. The DSAReqCmMac field defines the MAC address for the cable modem 109 receiving the DSA request, while the DSAReqId contains the RequestID identifying the DSA request associated with that entry.

The DSAReqStatus and DSAReqDirection fields correspond to the DsxPktClassStatus field and DsxPktClassDirection field, respectively, described with reference to the packet classifier table 1203 above, and thus will not be discussed in detail. The DSAReqServFlowQosRef field is an identifier field that identifies an entry in the QoS ParamSets table 1209 that corresponds to the DSA request, while the DSAReqServFlowQoSCount field is an identifier field that identifies the number of entries in the QoS ParamSets table 1209 that correspond to the DSA request. Similarly, the DSAReqPktClassRef is an identifier field that identifies an entry in the packet classifiers table 1205 that corresponds to the DSA request, while the, DSAReqPktClassCount field is an identifier field that identifies the number of entries in the packet classifiers table 1205 that correspond to the DSA request. The DSAReqPHSCount field is an identifier field that then identifies an entry in the payload header suppression rules table 1207 that corresponds to the DSA request.

The dynamic service delete request table 1213 defines a DSD request. Each entry in the dynamic service delete request table 1213 includes the following fields: DSDReqCmMac, DSDReqId, DSDReqStatus, and DSDReqServiceFlowId. The DSDReqCmMac, DSDReqId, and DSDReqStatus fields correspond to the DSAReqCmMac, DSAReqId, DSAReqStatus fields, respectively, of the dynamic service add request table 1213 described above, and thus will not be discussed in detail. The DSDReqServiceFlowId identifies the service flow ID (or “SFID”) used by the cable modem termination system 107 to identify the service flow to be deleted by the request.

The dynamic service change request table 1217 defines a DSC request. Each entry in this table includes the following fields: DSCReqCmMac, DSCReqId, DSCReqStatus, DSCReqDirection, DSCReqServiceFlowId, DSCReqServiceFlowSID, DSCReqServFlowQosRef, DSCReqServFlowQosCount, DSCReqPktClassRef, DSCReqPktClassCount, and DSCReqPHSCount. The DSCReqCmMac, DSCReqId, DSCReqStatus fields correspond to the DSAReqCmMac, DSAReqId, DSAReqStatus fields, respectively, of the dynamic service add request table 1213 described above, and thus will not be discussed in detail.

The DSCReqDirection field is an identifier field that identifies the direction of the service flow to be changed by the DSC request, while the DSCReqServiceFlowId field and the DSCReqServiceFlowSID field identifies the SFID and SID identifying the service flow to be changed by the DSC request, respectively. The DSCReqServFlowQosRef field is an identifier field that then identifies an entry in the QoS ParamSets table 1209 corresponding to the DSC request, while the DSCReqServFlowQosCount field is an identifier field that identifies the number of entries in the QoS ParamSets table 1209 corresponding to the DSC request. Similarly, the DSCReqPktClassRef field is an identifier field that identifies an entry in the packet classifiers table 1205 corresponding to the DSC request, while the DSCReqPktClassCount field is an identifier field that identifies the number of entries in the packet classifiers table 1205 corresponding to the DSC request. The DSCReqPHSCount field is an identifier field that identifies an entry in the payload header suppression rules table 1207 corresponding to the DSC request.

Lastly, the management information base 147 includes a response table 1217. Responses to DSx requests from the cable modem 109 are returned in this table. This table may include the identities of allocated resources such as SFIDs, SIDs, and PacketClassIds as well as any error codes and messages.

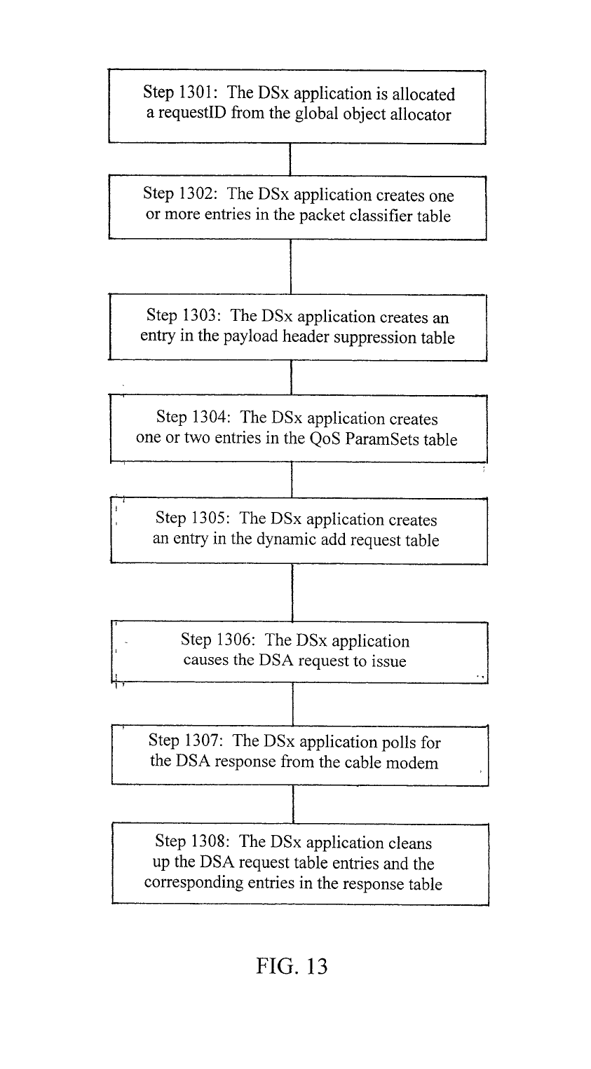

The process for forming a DSA request using the above-described tables will now be discussed with reference to FIG. 13. A DSA request can either be a basic request or a complex request. A basic DSA request contains only one set of QoS parameters, a packet classifier, and an optional payload header suppression rule. A complex DSA request contains multiple packet classifiers, such that each packet classifier may be associated with a different set of QoS parameters and an optional payload header suppression rule.

As seen in these figures, the DSA request is initiated when the DSx application initiating the DSA request is allocated a RequestID from the global object allocator 1201. The DSx application can, for example, use a sequence of an SNMP GET operation to obtain the current value of the allocator and an SNMP SET operation to verify that this value is reserved for use by the DSx application. If a value of zero is returned as the allocator value, then the GET and SET operation sequence is repeated to obtain a new allocator value. Similarly, if an inconsistent value error condition is returned from the SET operation, then the GET and SET operation sequence is repeated to obtain a new allocator value.

Next, in step 1302, the DSx application constructs one or more packet classifier templates using, for example, the SNMP SET operation to create one or more entries in the packet classifier table 1205. First, the DSx application sets the value of the DsxPktClassRef field for the entry or entries to the same value as the requested RequestID. Then, it sets the value of the DsxPktClassStatus field for the entry or entries to ‘createAndGo.’ Setting the value of this object to ‘createAndGo’ results in the corresponding table entry being created and immediately set to ‘active’.

If a basic DSA request is being defined in this process, it needs only one classifier so the DSA request definition employs only a single entry. The DSx application thus sets the value of the DSxPktClassSeq field for the entry to zero. Otherwise, the DSx application sequences each table entry corresponding to the DSA request beginning at one. The DSx application then sets the other fields in the entry (or entries) as required for matching the desired service flow's packet headers.

Next, if a payload header suppression rule is being associated with the packet classifier for the DSA request, then in step 1303, the DSx application creates an entry (or, for a complex DSA request, multiple entries) in the payload header suppression table 1207. Specifically, the DSx application enters the desired rule characteristics in the appropriate fields of a payload header suppression table 1207 entry. This entry uses the same RequestID and sequence numbers values for the DSxPHSRef and DSxPHSSeq fields, respectively, as its corresponding entry in the packet classifier table 1205. The DSx application then sets the value of the DSxPHSStatus field to ‘Create And Go.’ Next, in step 1304, the DSx application constructs a QoS parameter set template using, for example, the SNMP SET operation to create one or two entries in the QoS ParamSets table 1209. First, the DSx application sets the RequestID as the value of the DsxServiceFlowQosRef field for the entry (or entries), and sets the value of the corresponding DSxServiceFlowQosStatus field to ‘Create And Go.’ If the DSx application is creating a basic DSA request that only needs one set of QoS parameters, then it sets the value of the DSxServiceFlowQosSeq field to zero. Otherwise, it sets a sequence value for each table entry corresponding to the DSA request beginning at one.

The DSx application then sets the value of the DSxServiceFlowQosParamSetType field to ‘active,’ ‘admitted,’ or ‘active and admitted’ as required by the DSx application. The DSx application then sets the other fields in the entry to define the QoS parameters as required by the DSx application.

In step 1305, the DSx application actually constructs the DSA request by creating an entry in the dynamic service add request table 1213 using, for example, SNMP SET operations. First, the DSx application sets the value of the DSAReqCmMac field to the MAC address for the cable modem 109 receiving the DSA request. It then sets the value of the RequestID into the DSAReqId field, and sets the value of the DSAReqStatus field to ‘createAndWait.’

The DSx application also sets the value of the DSAReqDirection field as required by the DSx application to indicate the direction of the service flow being created. Further, it sets the value of the DSAReqServFlowQosRef field to the same value as the DSxServiceFlowQosRef field for the corresponding entry in the QoS ParamSets table 1209. The DSx application then sets the DSAServiceFlowQosCount field to indicate the number of sequenced entries that it created in the QoS ParamSets table 1209 for this DSA request. It also sets the DSAReqPktClassRef field to the same value as the DSxPktClassRef field for the corresponding entry in the packet classifier table 1205. The DSx application then sets the cadDSAPktClassCount field to indicate the number of sequenced entries created in the packet classifier table 1205 for this DSA request.

If any payload header suppression rules were created in the payload header suppression table 1207, then DSx application sets the DSAReqPHSRef field to the same value as the DSxPHSRef field for the corresponding entry in the payload header suppression table 1207. Otherwise, it sets this value to zero. The DSx application also sets the DSAPHSCount field to indicate the number of sequenced entries created in payload header suppression table 1207 for this DSA request. It should be noted that the sequence numbers in the payload header suppression table 1207 must match the same sequence numbers in packet classifer table 1205. However, because not all packet classifiers have a payload header suppression rule, the sequence numbers are not necessarily contiguous. Therefore, the DSx application sets the value of the DSAPHSCount field to the actual number of entries, not the highest sequence number.

In step 1306, the DSx application causes the DSA request to issue by setting the value of the DSAReqStatus field for the entry corresponding to the request to ‘active.’ Again, this value can be submitted to the field using an SNMP SET operation. When the value of the DSAReqStatus field for entry corresponding to the request to ‘active,’ the SNMP agent notifies the DSx agent to retrieve the values from the template table entries referenced in the active dynamic service add request table 1213 entry, and generate a DSA request to the cable modem 109 using these retrieved values.

Next, in step 1307, the DSx application polls for the DSA response from the cable modem 109 using, for example, a SNMP GET operation. More particularly, the DSx application checks the response table 1217 entry corresponding to the DSA request by identifying the entry in the response table 1217 having the values of a DSxRspCmMac field and a DSxRspId field that match the values of the DSAReqCmMac field and the RequestID for the DSA request, respectively.

When the DSxRspStatus value is changed to ‘active,’ the DSA Request is completed, and one or more DSx response entries may be returned to the management information base 147 to document all the resources allocated or errors encountered. These entries are sequenced using the DSxRspSeq field up to the DsxRspLastSeq field. If a basic DSA request was constructed (i.e., a request using single template table entries with a sequence number of zero), then the DSxRspSeq value is also zero. Otherwise, it begins with one.

If the cable modem 109 returned a value for a DSxRspServiceFlowId field that was non-zero, then the DSA Request was successful. Also, if the DSA request was for an upstream service flow, then the cable modem 109 will return a non-zero value for a DSxRspServiceFlowSID field in the response table 1219 as well. If any packet classifiers or payload header suppression rules were added by the DSA request, then the allocated packet classifier IDs are returned by the cable modem 109 to a DSxRspPktClassId field in the response table 1219 (with one packet classifier ID per sequenced DSxRspTable field entry corresponding to the sequence in the packet classifier table 1205 for this DSA Request).

On the other hand, if the cable modem 109 returned a value of zero to the DSxRspServiceFlowId field, then the DSA request failed. As known in the art, a failure could result from an error in the QoS parameters or the packet classifier values, or if there were insufficient resources in the cable modem termination system 108 or the cable modem 109 to create the service flow.

If the cable modem 109 returns a non-zero value for a DSxRspServFlowQosRef field in the table 1219, then there was an error in the QoS parameters identified by the value in the DSxRspServFlowQosSeq field in the QoS ParamSet table 1209. This error could also result of the cable modem termination system 108 or the cable modem 109 could not allocate the resources for the service flow. Non-zero values for a DsxRspServFlowQosErroredParam field, a DsxRspServFlowQosErrorCode field, and a DSxRspServFlowQosErrorMessage field in the response table 1219 identify the specific nature of the problem.

If the cable modem 109 returns a non-zero value for a DSxRspPktClassRef field in the response table 1219 entry, then there was an error in the packet classifiers or the payload header suppression rules identified by the value of the DSxRspPktClassSeq field in the packet classifier table 1205 or payload header suppression rules table 1207. Nonzero values in a DsxRspPktClassErroredParam field, a DsxRspPktClassErrorCode field, and a DSxRspPktClassErrorMessage field in the response table 1219 entry identify the nature of a problem relating to the packet classifiers, while non-zero values in a DSxRspPHSErroredParam field, a DSxRspPHSErrorCode field, and a DSxRspPHSErrorMessage field of the response table 1219 entry identify the nature of a problem relating to the payload header suppression rules.

Lastly, in step 1308, the DSx application cleans up the DSA request table entries and the corresponding entries in the response table 1219. First, it clears the response table 1219 entry for the DSA response by setting the value of a DSxRspStatus field in that table to ‘destroy.’ It should be noted, however, that the DSx application must delete this value before issuing another DSA request using the same RequestID.

If the template table entries built for this DSA request are not going to be reused for any further DSx requests by the DSx application, then the DSx application sets the value of the each of the DsxPktClassStatus field, the DSxPHSStatus field, and the DSxServiceFlowQosStatus field to ‘destroy.’ Similarly, if the dynamic service add request table 1213 entry for the DSA request is not going to be reused for any further DSA requests, then the DSx application sets the value of the DSAReqStatus field to ‘destroy’ as well.

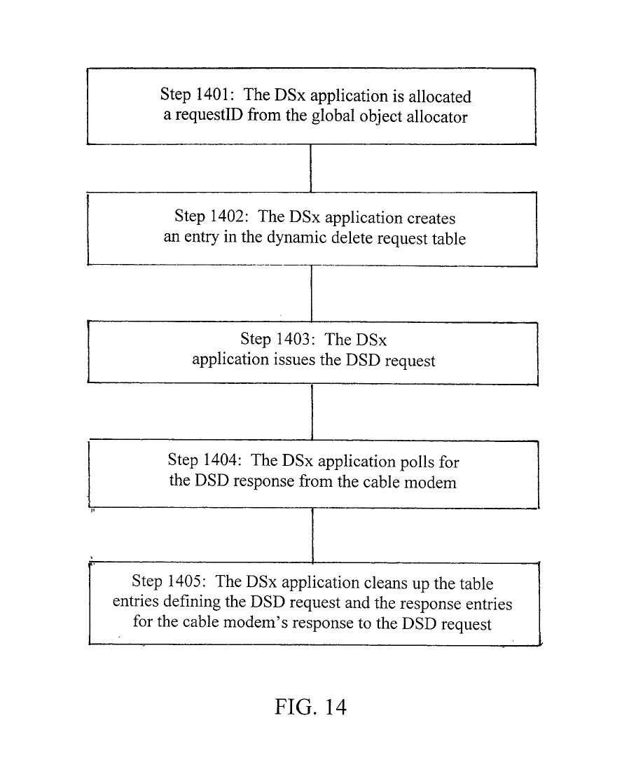

A dynamic service delete request is structured according to the method shown in FIG. 14. A DSD request must identify the cable modem and the service flow ID or “SFID” used by the cable modem termination system 107 to identify the service flow to be deleted. The DSD request releases all resources in the cable modem termination system 107 and the cable modem 109 associated with the service flow, but only one service flow can be deleted with a DSD request.

The construction of the DSD request begins in step 1401 when the DSx application is allocated a RequestID from the global object allocator 1201. The DSx application can, for example, use a sequence of an SNMP GET operation to obtain the current value of the allocator and an SNMP SET operation to verify that this value is reserved for use by the DSx application. If a value of zero is returned as the allocator value, then the GET and SET operation sequence is repeated to obtain a new allocator value. Similarly, if an inconsistent value error condition is returned from the SET operation, then the GET and SET operation sequence is repeated to obtain a new allocator value.

Next, in step 1402, the DSx application constructs the DSD request by creating an entry in the dynamic service delete request table 1215 using, for example, SNMP SET operations to create the entry. First, DSx application sets the value of the cadDSDReqCmMac field to the MAC address for the cable modem 109 receiving the DSD request. It also sets the value of the cadDSDReqId field to the RequestID, the value of the DSDServiceFlowId field to the service flow's SFID, and the value of the DSDReqStatus to ‘createAndWait.’

Then, in step 1403, the DSx application issues the DSD request by setting the value of the DSDReqStatus field for the entry to ‘active.’ In step 1404, it polls for the DSD response from the cable modem 109. More particularly, using, for example, the SNMP GET operation, the DSx application identifies the entries of the response table 1219 having values of the DSxRspCmMac field and the DSxRspId field that match the DSDReqCmMac values and the RequestID value, respectively.

When the value of the DSxRspStatus field is changed to ‘active,’ the DSD request is completed. Only one DSx response entry will be returned to document the result or errors encountered. Accordingtly the value for DSxRspSeq field is always zero for a DSD Request.

If the cable modem 109 returns a zero value for the DSxRspServiceFlowId field, then the DSD request was successful. If, however, the value of DSxRspServiceFlowId field is non-zero, then the DSD request's SFID was been returned and the DSD request has failed. As is known in the art, such a failure could result if the SFID was unknown to the cable modem termination system 107 or the cable modem 109. Further, non-zero values of the DsxRspServFlowQosErrorCode field and the DSxRspServFlowQosErrorMessage field identify the nature of the problem.

In step 1405, the DSx application cleans up the table entries defining the DSD request and the response entries for the cable modem's response to the DSD request. First, it clears the response table 1219 entry for the DSD response by setting the value of the DSxRspStatus field to ‘destroy.’ This entry must be deleted, however, before the DSx application can issue another DSD request using the same RequestID. If the entry for the DSD request in the dynamic service delete request table 1215 is not going to be reused for any further DSD requests, then the DSx application sets the value of the DSDReqStatus field for this entry to ‘destroy.’

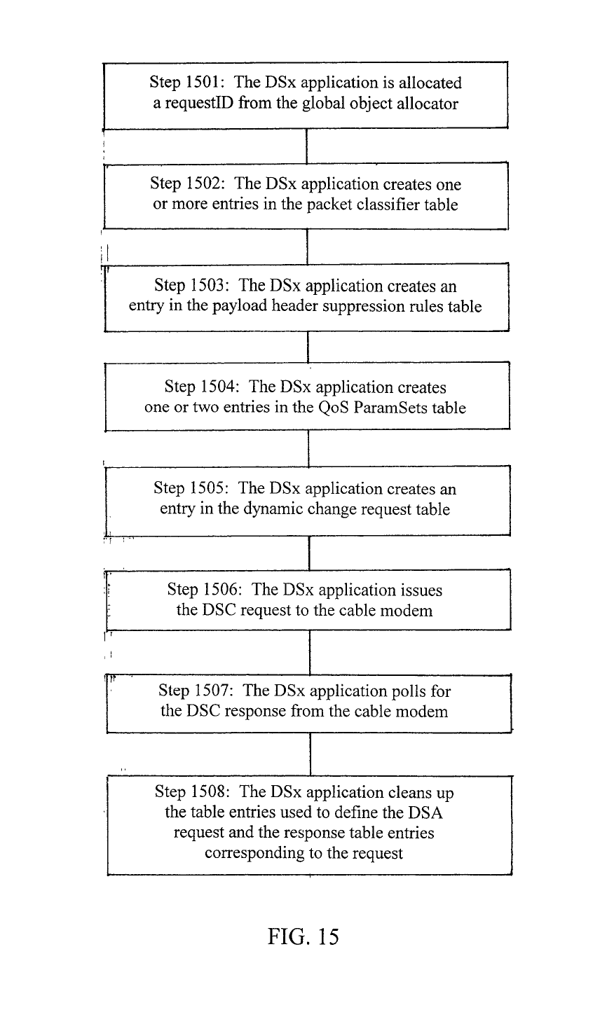

Like a DSA request, a DSC request also can be structured as a basic request or as a complex request. The procedure for defining a DSC request is shown in FIG. 15. As seen in this figure, construction of the DSC request begins in step 1501 when the DSx application is allocated a RequestID from the global object allocator 1201. The DSx application can, for example, use a sequence of an SNMP GET operation to obtain the current value of the allocator and an SNMP SET operation to verify that this value is reserved for use by the DSx application. If a value of zero is returned as the allocator value, then the GET and SET operation sequence is repeated to obtain a new allocator value. Similarly, if an inconsistent value error condition is returned from the SET operation, then the GET and SET operation sequence is repeated to obtain a new allocator value.

If any packet classifiers are being added, modified, or removed by the DSC request, then, in step 1502, the DSx application creates one or more entries in the packet classifier table 1205. First, the DSx application sets the value of the DSxPktClassRef field to the RequestID, and sets the value of the DSxPktClassStatus field to ‘create and go.’ Setting this field to ‘create and go’ results in the table entry being created and immediately set to ‘active’.

If the DSC request is a basic request that only needs one classifier, then the DSx application sets the value of the DSxPktClassSeq to zero. Otherwise, it sequences each associated table entry beginning at one. The DSx application also sets the value of the DSxPktClassId field to the packet classifier ID that identifies the packet classifier for the service flow being changed. This packet classifier ID may have been returned, for example, by a previous DSA or DSC response from the cable modem 109. The DSx application sets the value of this field to zero if the packet classifier in the DSC request is being added to the service flow for the first time. The DSx application also sets the value of the DSxPktClassChgAction to indicate the nature of the change desired by the DSA request, and sets the other classifier fields as required for matching the service flow's packet headers.

If any payload header suppression rules are being added, modified, or removed by the DSC request, then the DSx application creates an entry in the payload header suppression rules table 1209 in step 1503. Specifically, it sets the value of the DSxPHSRef field and the DSxPHSSeq field to the same RequestID and sequence number that was used to create the entries in the packet classifier table 1205, respectively. It also sets the valued of the DSxPHSStatus field to ‘create and go.’

The DSx application further sets the value of the DSxPHSPktClassId to the packet classifier ID that identifies the packet classifier for the service flow being changed. This packet classifier ID may have been returned, for example, by a previous DSA or DSC response from the cable modem. The DSx application sets the value of this field to zero if the payload header suppression rule in the DSA request is being added to the service flow for the first time. Next, the DSx application sets the value of the DSxPHSChgAction field to indicate the nature of the change desired. It also sets other payload header suppression rule fields as required for compressing this classifier's packet headers.

If any sets of QoS parameters are being added, modified, or removed, then the DSx application creates one or two entries in the QoS ParamSets table 1209 in step 1504. First, it sets the value of the DSxServiceFlowQosRef field to the RequestID, and sets the value of the DSxServiceFlowQosStatus field to ‘Create And Go.’ If this is a basic DSC Request that only needs one set of QoS parameters, the DSx application sets the value of the DSxServiceFlowQosSeq field to zero. Otherwise, it sequences each table entry beginning at one.

The DSx application then sets the value of the DSxServiceFlowQosParamSetType field to ‘null,’ ‘active,’ ‘admitted,’ or ‘active and admitted’ as required. It then sets the other fields in the QoS ParamSets table 1209 as required for defining the service flow's QoS behavior.

Next, in step 1505, the DSx application constructs the DSC request by creating an entry in the dynamic service change request table 1217. First, it sets the value of the DSCReqCmMac field to the MAC address of the cable modem 109 to receive the DSC request, and the value of the DSCReqId field to the requested RequestID. It also sets the value of the DSCReqStatus field to ‘create and wait.’

The DSx application also sets the value of the DSCReqServiceFlowId field to the SFID of the service flow being modified. The SFID may have been returned by a previous DSA response, for example. If the DSC request is for an upstream service flow, the service level agreement change application 159 sets the value of the DSCReqServiceFlowSID field to the SID of the service flow being modified (which also may have been returned by a previous DSA response).

The DSx application further sets the value of the DSCReqDirection field as required to indicate the direction of the service flow being modified. It then sets the value of the DSCReqServFlowQosRef field to the same value as the DSxServiceFlowQosRef field if a QoS parameter set is being modified with the DSC request, or sets the value of this field zero if no QoS parameter sets are being modified by this DSC request.

Next, the DSx application sets the value of the DSCServiceFlowQosCount field to indicate the number of sequenced entries created in QoS ParamSets table 1209 for this DSC request. If the DSC request is modifying a packet classifier or payload header suppression rules, then it also sets the value of the DSCReqPktClassRef field to the value of the cadDSxPktClassRef. Otherwise, it sets the value of this field to zero.

The DSx application then sets the value of the DSAPktClassCount field to indicate the number of sequenced entries created in the packet classifier table 1205 for this request. If any payload header suppression rules were created in the payload header suppression rules table 1207 for this DSC request, then (if not already done above) the DSx application sets the value of the DSCReqPktClassRef field to the value of the DSxPHSRef field. Otherwise, it sets the value of the DSCReqPktClassRef field to zero if the DSC request is not modifying any packet classifiers or payload header suppression rules.

Next, the DSx application sets the value of the DSCPHSCount field to indicate the number of sequenced entries created in payload header suppression rules table 1209 for this request. As with the DSA request, the DSx application must match the sequence numbers in the payload header suppression rules table 1209 with the same sequence numbers in the packet classifier table 1205. However, as not all packet classifiers will have associated payload header suppression rules, the sequence numbers are not necessarily contiguous. Thus, the DSx application sets the value of the DSCPHSCount field to the actual number of entries rather than the highest sequence number.

In step 1506, the DSx application issues the DSC request to the cable modem 109 by setting the value of the DSCReqStatus field to ‘active’ for the entry corresponding to the DSC request. The DSx application then polls for the DSC response from the cable modem 109 in step 1507. More particularly, the DSx application identifies the appropriate entry in the response table 1219 by matching the DSCReqCmMac and RequestID values to the values of the DSxRspCmMac field and the DSxRspId field in the response table 1219, respectively.

When the value of the DSxRspStatus field is changed to ‘active,’ the DSC request has completed. One or more DSx response entries may then be returned by the cable modem 109 to the response table 1219, to document all the resources allocated or errors encountered. These entries are sequenced using the value of the DSxRspSeq field up to the value of the DsxRspLastSeq field. If a basic DSC Request was constructed (i.e., with template table having only a single entry and a sequence number of zero), then the value of the DSxRspSeq is also zero. Otherwise, the value of this field begins with one up to the value of the DsxRspLastSeq field.

If the cable modem 109 returns a non-zero value to the DSxRspServiceFlowId field, then the DSC request was successful. Also, if the DSC request was directed to an upstream service flow, then the value of the DSxRspServiceFlowSID field is also nonzero. If any packet classifiers were added or modified by the DSC request, then the allocated packet classifier IDs are returned in the DSxRspPktClassId field (one per sequenced entry in the response table 1219 corresponding to the sequence of entries in the packet classifier table 1205 for the DSC request).

If, on the other hand, the value of the DSxRspServiceFlowId field is zero, then the DSC request failed. Such a failure could result from, for example, errors in the QoS ParamSets table 1209 or the packet classifier table 1205, or if there were insufficient resources in the cable modem termination system 107 or the cable modem 109 to modify the service flow. If the value of the field DSxRspServFlowQosRef is non-zero, then there was an error in the entry identified by the value of DSxRspServFlowQosSeq in the QoS ParamSet table 1209. It is also possible that the cable modem termination system 107 or the cable modem 109 could not allocate the resources for the service flow. Nonzero values returned from the cable modem 109 to the DsxRspServFlowQosErroredParam field, the DsxRspServFlowQosErrorCode field, and the DSxRspServFlowQosErrorMessage field identify the nature of the problem.

If the value of the DSxRspPktClassRef field is non-zero, then there was an error in the packet classifiers or payload header suppression rules identified in the packet classifier table 1205 or the payload header suppression rules table 1207, respectively, by the value of the DSxRspPktClassSeq field. Non-zero values in the DsxRspPktClassErroredParam field, the DsxRspPktClassErrorCode field, and the DSxRspPktClassErrorMessage field then identify the nature of the problem if it is related to the packet classifiers in the request, while non-zero values in the DSxRspPHSErroredParam field, the DSxRspPHSErrorCode field, and the DSxRspPHSErrorMessage field identify the nature of the problem relating to payload header suppression rules.

In step 1508, the DSx application cleans up the table entries used to define the DSC request and the response table entries corresponding to the request. First, it clears the entry in the response table 1219 for the DSC response by setting the value of the DSxRspStatus field to ‘destroy.’ The DSx application must delete this entry, however, before issuing another DSC request using the same RequestID.

If the template table entries built for the DSC request are not going to be reused for any further DSx Requests by this DSx application, then the DSx application sets the value of the DsxPktClassStatus field, the DSxPHSStatus field, and the DSxServiceFlowQosStatus field for these entries to ‘destroy.’ Similarly, if the entry in the dynamic service change request table 1217 for this DSC request is not going to be reused for any further DSC requests, then the DSx application sets the value of the DSCReqStatus for this entry to ‘destroy’ as well.

Accordingly, as described above, the management information base 147 according to the invention can be used to conveniently and precisely define the characteristics for any DSx protocol request.

### X. Conclusion

The present invention has been described above by way of specific exemplary embodiments, and the many features and advantages of the present invention are apparent from the written description. Thus, it is intended that the appended claims cover all such features and advantages of the invention. Further, since numerous modifications and changes will readily occur to those skilled in the art, the specification is not intended to limit the invention to the exact construction and operation as illustrated and described. For example, the invention may include any one or more elements from the apparatus and methods described herein in any combination or subcombination. Accordingly, there are any number of alternative combinations for defining the invention, which incorporate one or more elements from the specification (including the drawings, claims, and summary of the invention) in any combinations or subcombinations. Hence, all suitable modifications and equivalents may be considered as falling within the scope of the appended claims.

What is claimed is:

1. A management information base for defining a DSx protocol request, comprising:
a plurality of template tables, each of the template tables containing at least one characteristic field for storing a DSx protocol request characteristic; and
a plurality of request tables, at least one of the request tables
corresponding to a particular type of DSx protocol request and
having one or more identifier fields for containing an identifier identifying a field in one of the plurality of template tables containing a DSx protocol request characteristic, the one or more identifier fields corresponding to a DSx request such that characteristics contained in the fields indentified in the one or more identifier fields define the DSx request.

2. The management information base recited in claim 1, wherein the template tables include a quality-of-service parameter table for containing quality of service parameters, a packet classifier table for containing packet classifiers, and a payload header suppression rules table for containing payload header suppression rules.

3. The management information base recited in claim 1, wherein the plurality of request tables includes a dynamic service add request table, a dynamic service change request table, and a dynamic service delete request table.

4. The management information base recited in claim 1, further including an allocator for allocating values employed in the request tables for identifying a specific DSx request.

5. The management information base recited in claim 1, further including a response table for storing response information provided in response to a DSx request defined by the management information base.

6. The management information base recited in claim 1, wherein each of the request tables includes a field for storing a status of the DSx request.

7. A data structure, comprising:
a plurality of template tables, each of the template tables containing at least one characteristic field storing a type of DSx protocol request characteristic; and
a plurality of request tables, at least one of the request tables
corresponding to a particular type of DSx protocol request and
having one or more identifier fields containing an identifier identifying a characteristic field in one of the plurality of template tables containing a DSx protocol request characteristic, the one or more identifier fields corresponding to a DSx request such that characteristics contained in the fields indentified in the one or more identifier fields define the DSx request.

8. The data structure recited in claim 7, wherein the template tables include a quality-of-service parameter table for containing quality of service parameters, a packet classifier table for containing packet classifiers, and a payload header suppression rules table for containing payload header suppression rules.

9. The data structure recited in claim 7, wherein the plurality of request tables includes a dynamic service add request table, a dynamic service change request table, and a dynamic service delete request table.

10. The management information base recited in claim 1, further including an allocator for allocating values employed in the request tables for identifying a specific DSx request.

11. The data structure recited in claim 7, further including a response table storing response information provided in response to a DSx request defined by the management information base.

12. The data structure recited in claim 7, wherein each of the request tables includes a field storing a status of the DSx request.

13. A method of constructing a DSx protocol request, comprising:
receiving one or more DSx request messages, each DSx request message setting forth a characteristic to be included in a DSx request;
for each DSx message,
assigning the characteristic to a characteristic field in one of a plurality of template tables; and
assigning an identifier to an identifier in a request table entry identifying the field in the template table for the characteristic; and
providing each characteristic in a field identified by an identifier in the request table for a DSx request to a DSx manager to prepare a DSx request.

14. The method of claim 13, wherein the template tables include a quality of service parameter set table, a packet classifier table, and a payload header suppression rules table.

15. The method of claim 13, wherein the request table corresponds to one of a dynamic service add request, a dynamic service change request, and a dynamic service delete request.

16. The method of claim 13, further including receiving response values in response to the DSx request prepared by the DSx agent.

17. The method of claim 13, further including assigning a DSx request identifier value for all of the identifier fields in a request table entry associated with the DSx request.

18. A method of dynamically changing a service level of a subscriber to a communications network service, comprising:
receiving a request from a subscriber to dynamically change a service flow for the service;
contacting a database to obtain an address for a cable modem and cable modem termination system associated with the subscriber; and
providing the characteristics for the new service flow and the address for the cable modem to the cable modem termination system to execute the new service flow.

19. The method of claim 18, wherein the designated characteristics for a new service flow is provided by a cable modem manager managing the cable modem.

20. The method of claim 18, wherein the subscriber provides the designated characteristics for a new service flow by referencing service flow information contained in a cable modem manager managing the cable modem.

21. The method of claim 18, wherein the designated characteristics for a new service flow for are provided by a content server providing content to the subscriber.

22. The method of claim 18, wherein the database is a cable modem manager.

23. The method of claim 18, wherein the request from the subscriber requests a temporary change in service flow.

24. The method of claim 18, wherein the request from the subscriber requests a permanent change in service flow.

25. A system for allowing a subscriber to request a dynamic change in a service level of a communications network service, comprising:
a service manager for receiving a request from a subscriber to dynamically change a service flow and an instruction designating characteristics for a new service flow;
a cable modem termination system for implementing a new service flow having the characteristics set forth in the instruction;
a cable modem manager for providing the service manager with an address for a cable modem associated with the subscriber and an address of the cable modem termination system in response to the request;
the service manager forwarding the characteristics set forth in the instruction to the cable modem termination system upon receiving the address for the cable modem and the address for the cable modem termination system from the cable modem manager.

26. The system of claim 25, wherein the instruction designating characteristics for a new service flow is provided by the subscriber

27. The system of claim 26, wherein the subscriber provides the instruction by referencing service flow information contained a cable modem manager.

28. The system of claim 25, wherein the instruction designating characteristics for a new service flow is provided by a content server providing content to the subscriber.

29. The system of claim 25, wherein the request from the subscriber requests a temporary change in service flow.

30. The system of claim 25, wherein the request from the subscriber requests a permanent change in service flow.
